(19) United States
(12) Patent Application Publication
(10) Pub. No.: US 2010/0116813 A1
(43) Pub. Date: May 13, 2010

(54) HEAT GENERATION UNIT

(75) Inventors: Akira Nishio, Kagawa (JP); Masanori Konishi, Kagawa (JP); Tsugunori Okahara, Kagawa (JP); Hiroaki Matsuoka, Kagawa (JP)

Correspondence Address: HAMRE, SCHUMANN, MUELLER & LARSON P.C., P.O. BOX 2902, MINNEAPOLIS, MN, 55402-0902, US

(73) Assignee: Panasonic Corporation, Kadoma-shi (JP)

(21) Appl. No.: 12/596,783

(22) PCT Filed: Apr. 18, 2008
(86) PCT No.: PCT/JP2008/001023

§ 371 Date: Oct. 20, 2009

(30) Foreign Application Priority Data
Apr. 27, 2007 (JP) 2007-119119

(51) Int. Cl. H05B 3/02; H05B 3/06

(52) U.S. Cl. 219/482; 219/520

(57) ABSTRACT

In a heat generation unit of the present invention, a holder having an elastic force tube used for holding a film-sheet-shaped heat generation element that generates heat upon application of a voltage thereto is disposed in a container together with the heat generation element. The heat generation element is held in a predetermined position in the container by the elastic force of the holder, with electric power being supplied from power supply members thereto through the holder, so that the heat generation element can be reliably held in the container, with a partial heat generation in the holder of the heat generation element being suppressed.

### TECHNICAL FIELD

The present invention relates to a heat generation unit to be used as a heat source for a heating apparatus, and in particular relates to a heat generation unit having a heat generation element that is mainly composed of a carbonaceous substance and formed into a film-sheet shape. Examples of the heating apparatus in which the heat generation unit of the present invention is used include various kinds of apparatuses that require a heat source, such as an electric appliance like an electric stove, a cooking device and a dryer, and an electronic apparatus like a copying machine, a facsimile and a printer.

### BACKGROUND ART

A heat generation unit that has been used as a heat source for a conventional heating apparatus utilizes a heat generation element mainly composed of a carbonaceous substance. Such a heat generation element has various kinds of shapes, such as a rod shape, a flat-plate shape and a film-sheet shape, and is secured at a predetermined position in a container of the heat generation unit by using holding means that is suitable for each of these shapes.

In the heat generation unit used as a heat source in a conventional heating apparatus, for example, Japanese Unexamined Patent Publication No. 2002-063870 has proposed a method as the holding method for a film-sheet-shaped heat generation element. In the method disclosed in Japanese Unexamined Patent Publication No. 2002-063870, a heat generation element, formed by winding around a belt member made of a carbonaceous substance around in a helical form, is sandwiched by a contact member having an outer face formed by a metal plate that has bent portions, with graphite paper interposed therebetween, and the opposing portions of the contact member are welded so that the heat generation element is anchored to the contact member to be held thereon (first holding method).

Moreover, another holding method for a heat generation element in the conventional heating apparatus includes a holding method for a flat-plate-shaped heat generation element. For example, Japanese Unexamined Patent Publication No. 2001-155844 has disclosed a holding method (second holding method) in which molybdenum thin plates are made tightly in contact with two faces of a holder in the flat-plate-shaped heat generation element, with the heat generation element being firmly sandwiched by the inner faces of two U-letter shaped blocks by inserting pins thereto, while the molybdenum thin plates on the two faces are interposed therebetween.

### DISCLOSURE OF INVENTION

### Problems to be Solved by the Invention

In the first holding method for the conventional heat generation unit, an end portion of the film-sheet-shaped heat generation element made of a carbonaceous substance is sandwiched by a contact member made of a metal plate having bent portions with graphite paper interposed therebetween, and one portion of the contact member is further welded so that the heat generation element is anchored to be held and secured into the heat generation unit. In such a conventional holding method, since a tightening pressure is extremely concentrated on one portion of the heat generation element near the welded portion, the heat generation element and the contact member are brought into a non-uniform contact state to cause a partial high temperature in a contact portion thereof. Moreover, a thermal stress caused by the partial high-temperature portion of the heat generation element and a mechanical stress due to the non-uniform contact tend to cause a problem of a high possibility of occurrence of cracks in the heat generation element.

The second conventional holding method uses a holding method in which molybdenum thin plates are made tightly in contact with the two faces of a flat-plate-shaped heat generation element and the heat generation element is sandwiched by two blocks with the molybdenum thin plates interposed therebetween, with pins being inserted therein. Therefore, high machining precision is required for members, such as blocks serving as holding means. In the case where holding means using members with poor machining precision on is used, a non-uniform contact tends to occur, for example, between the heat generation element and the blocks in the same manner as in the first holding method, to cause problems of a partial heat generation and occurrence of a crack in the holder of the heat generation element.

In order to solve the above-mentioned problems in the conventional holding methods for a heat generation unit, an object of the present invention is to solve the above-mentioned problems and to provide a heat generation unit that can suppress a partial heat generation in the holder relative to the heat generation element and reliably hold the heat generation element, with superior safety and high reliability.

### Means for Solving the Problems

In order to solve the above-mentioned problems of a conventional heat generation element and to achieve the above-mentioned object, a heat generation unit according to a first aspect of the present invention includes:

a heat generation element having a film-sheet shape that generates heat when a voltage is applied thereto;

power supply members that supply power to the heat generation element;

a holder having an elastic force that is used for holding the heat generation element; and

a container that contains the heat generation element and the holder therein, wherein

the heat generation element is held at a predetermined position inside the container by the elastic force of the holder, and the power from the power supply members is supplied through the holder. The heat generation unit of the present invention having such a structure makes it possible to provide a heat generation unit that can suppress a partial heat generation in the holder relative to the heat generation element and reliably hold the heat generation element, with superior safety and high

According to a second aspect of the present invention, the heat generation element according to the first aspect may be pressed onto an inner wall face of the container by an expanding operation of the holder to be held thereon.

According to a third aspect of the present invention, the container according to the second aspect may further include a cylindrical portion that contains the heat generation element and the holder, and

the holder may include an arc portion having a shape corresponding to the inner wall face of the container, the arc portion in a free state that is a state prior to a regulated state having a diameter that is greater than a diameter of the cylindrical portion, the arc portion in a regulated state having a diameter that is smaller than the diameter of the cylindrical portion, with the heat generation element being held by an expanding operation of the arc portion.

According to a fourth aspect of the present invention, the container according to the second aspect may further include a cylindrical portion that contains the heat generation element and the holder, and

the holder may include a spiral portion prepared by forming a wire member into a coil shape, the spiral portion in a free state that is a state prior to a regulated state having a diameter that is greater than the diameter of the cylindrical portion, the spiral portion in a regulated state having a diameter that is smaller than the diameter of the cylindrical portion, with the heat generation element being held by an expanding operation of the spiral portion.

According to a fifth aspect of the present invention, the heat generation element according to the third aspect may be formed by a material having a two dimensional isotropic thermal conductivity, with the thermal conductivity being set to a conductivity of 200 W/m·K or more.

According to a sixth aspect of the present invention, the heat generation element according to the third aspect may be formed by a graphite film obtained by subjecting a polymer film to heating treatment at a temperature of 2400° C. or more.

According to a seventh aspect of the present invention, the heat generation element according to the first aspect may be held by a sandwiching operation of the holder, and the holder and the holder may be secured onto a predetermined position on the container by an expanding operation of the holder placed in contact with the container.

According to an eighth aspect of the present invention, the container according to the seventh aspect may further include a cylindrical portion that contains the heat generation element and the holder, and

the holder may include an arc portion having a shape corresponding to the inner wall face of the container and a sandwiching portion having a flat face, the arc portion in a free state that is a state prior to a regulated state having a diameter that is greater than the diameter of the cylindrical portion, the arc portion in a regulated state having a diameter that is smaller than the diameter of the cylindrical portion, with the heat generation element being held by respective portions of the sandwiching portion of the holder after the regulated state.

According to a ninth aspect of the present invention, the heat generation element according to the eighth aspect may be formed by a material having a two dimensional isotropic thermal conductivity, with the thermal conductivity being set to a conductivity of 200 W/m·K or more.

According to a tenth aspect of the present invention, the heat generation element according to the eighth aspect may be formed by a graphite film obtained by subjecting a polymer film to heating treatment at a temperature of 2400° C. or more.

According to an 11th aspect of the present invention, the holder according to the first aspect may include a first holding member and a second holding member, and may be structured so that, by a sandwiching operation of the first holding member and the second holding member, the heat generation element, placed between the first holding member and the second holding member, is held.

According to a 12th aspect of the present invention, one of the first holding member and the second holding member according to the 11th aspect may have an elastic property sp that one of the holding members is sandwiched and held by an elastic force of the other holding member.

According to a 13th aspect of the present invention, both of the first holding member and the second holding member according to the 11th aspect may have an elastic property so that one of the holding member is sandwiched and held by the other holding member by mutual elastic forces.

According to a 14th aspect of the present invention, the heat generation element according to the 12th aspect may be formed by a material having a two dimensional isotropic thermal conductivity, with the thermal conductivity being set to a conductivity of 200 W/m·K or more.

According to a 15th aspect of the present invention, the heat generation element according to the 12th aspect may be formed by a graphite film obtained by subjecting a polymer film to heating treatment at a temperature of 2400° C. or more.

Moreover, the heat generation unit of the present invention may have the following structures.

The holder may have a spring portion prepared by forming a wire member into a coil shape, and the length in expanding and contracting directions of the spring portion in a free state, that is, in a pre-regulated state, is made equal to or greater than the length of the housing portion of the container, while the length in expanding and contracting directions of the spring portion in a regulated state is made smaller than the length of the housing portion of the container, so that the heat generation element may be held by the expanding operation of the spring portion.

The holder may be structured to hold end portions of a plurality of heat generation elements.

The holder may be made of a conductive material so as to also exert a function as the power supply members.

The holder may be made of a thin metal plate.

The holder may be made of a metal wire.

An engaging means used for relatively positioning the first holding member and the second holding member may be formed between the first holding member and the second holding member.

Flat faces, used for sandwiching the heat generation element, may be respectively formed on the first holding member and the second holding member, and the heat generation element may be sandwiched between the flat face of the first holding member and the flat face of the second holding member so as to be fitted thereto.

At least either one of the first holding member and the second holding member may be made of a material having a conductive property.

Either one of the first holding member and the second holding member may be formed by a thin metal plate.

Either one of the first holding member and the second holding member may be formed by a metal wire.

The heat generation element may be made of a material mainly composed of carbon, and formed into a film-sheet shape with a thickness of 300 μm or less.

The container may be formed by a material having heat resistance selected from ceramic materials typically represented by alumina, cordierite, mullite, zirconia, magnesia and calcia.

The container may be formed by a material having heat resistance selected from glass materials typically represented by quartz glass, soda-lime glass, borosilicate glass and lead glass.

The heat generation unit may have a structure in which, with the two end portions of the container being sealed and adhered to each other, the container is kept in a vacuum state, or sealed with an inert gas.

The container may be kept in a vacuum state or sealed with a gas selected from rare gases typically represented by helium, neon, argon, krypton, xenon and radon, or a nitrogen gas, or a gas to which a halogen group added.

### EFFECT OF THE INVENTION

In accordance with the present invention, it is possible to provide a heat generation unit that can suppress a partial heat generation in a holder relative to the heat generation element and reliably hold the heat generation element, with superior safety and high reliability.

### BRIEF DESCRIPTION OF THE DRAWINGS

FIG. 1 is a perspective view showing a structure of a heat generation unit 1 according to embodiment 1 of the present invention.

FIG. 2 is views describing a contracting operation at the time when a holder 4 in the heat generation unit 1 of embodiment 1 is pressed.

FIG. 3 is cross-sectional views showing a holding state of a heat generation element 2 by a container 3 and a holder 4 in the heat generation unit 1 of embodiment 1.

FIG. 4 is a cross-sectional view showing another mode of the holder in the heat generation unit 1 of embodiment 1.

FIG. 5 is cross-sectional views showing still another mode of the holder in the heat generation unit 1 of embodiment 1.

FIG. 6 is cross-sectional views showing yet another mode of the holder in the heat generation unit 1 of embodiment 1.

FIG. 7 is a cross-sectional view showing a holding state of the heat generation element by the holder shown in FIG. 6.

FIG. 8 is a perspective view showing a structure of a heat generation unit in according to embodiment 2 of the present invention.

FIG. 9 is views describing a contracting operation at the time when a holder 4e in the heat generation unit in of embodiment 2 is pressed.

FIG. 10 is cross-sectional views showing a holding state of a heat generation element 2 by a container 3 and a holder 4e in the heat generation unit in of embodiment 2.

FIG. 11 is a perspective view showing a structure of a heat generation unit 1b according to embodiment 3 of the present invention.

FIG. 12 is views describing a holding operation by a holder 4h in the heat generation unit 1b of embodiment 3.

FIG. 13 is a cross-sectional view showing a holding state of a heat generation element 2 by a container 3 and a holder 4h in the heat generation unit 1b of embodiment 3.

FIG. 14 is a cross-sectional view showing another mode of the holder in the heat generation unit 1b of embodiment 3.

FIG. 15 is a cross-sectional view showing still another mode of the holder in the heat generation unit 1b of embodiment 3.

FIG. 16 is a cross-sectional view showing yet another mode of the holder in the heat generation unit 1b of embodiment 3.

FIG. 17 is a cross-sectional view showing a holding state of the heat generation element by the holder shown in FIG. 16.

FIG. 19 is a perspective view showing a structure of a heat generation unit 1c according to embodiment 4 of the present invention.

FIG. 19 is views showing a holding operation by a holder 4q in the heat generation unit ic of embodiment 4.

FIG. 20 is a cross-sectional view showing a holding state of a heat generation element by the holder shown in FIG. 19.

FIG. 21 is a cross-sectional view showing another mode of the holder in the heat generation unit ic of embodiment 4.

FIG. 22 is a cross-sectional view showing still another mode of the holder in the heat generation unit 1c of embodiment

FIG. 23 is a perspective view showing a structure of a heat generation unit 1d according to embodiment 5 of the present invention.

FIG. 24 is views showing a holding operation by a holder 4o in the heat generation unit 1d of embodiment 5.

FIG. 25 is a cross-sectional view showing a holding state of a heat generation element by the holder shown in FIG. 24.

FIG. 26 is a cross-sectional view showing another mode of the holder in the heat generation unit 1d of embodiment 5.

FIG. 27 is a cross-sectional view showing a holding state of a heat generation element by the holder shown in FIG. 26.

### BEST MODE FOR CARRYING OUT THE INVENTION

Preferred embodiments of a heat generation unit according to the present invention will be described below referring to the attached drawings.

### Embodiment 1

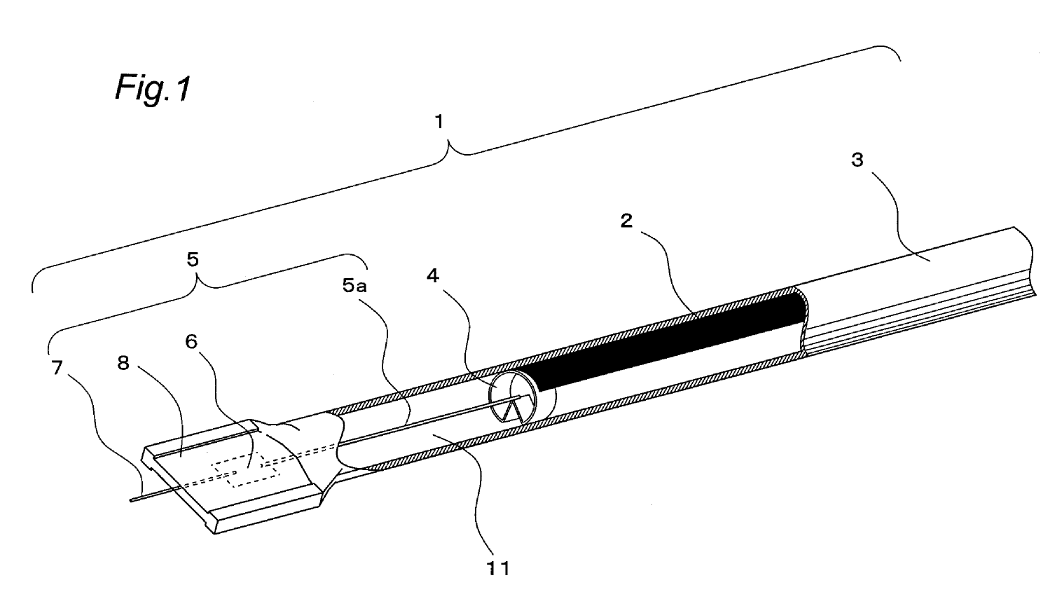

Referring to FIGS. 1 to 7, a heat generation unit according to embodiment 1 of the present invention will be described. FIG. 1 is a perspective view showing a structure of a heat generation unit 1 according to embodiment 1. In FIG. 1, since the heat generation unit 1 has an elongated shape with two ends in a longitudinal direction having the same structure, only one of the ends is shown, with the other end being omitted from the drawing.

In the heat generation unit 1 of embodiment 1, a film-sheet-shaped heat generation element 2, made of a material containing a carbonaceous substance, is disposed inside a container 3 made of quartz glass, with a cylindrical center portion. The heat generation element 2 is held by a holder 4 having elasticity and conductivity so as to be tightly made in contact with the inner wall of the container 3. Power supply members 5 that supply power to the heat generation element 2 are configured by an inner lead wire 5a, molybdenum foil 6 and an external lead wire 7. One end of the inner lead wire 5a is electrically connected to the holder 4, and the other end is electrically connected to the molybdenum foil 6. One end of the external lead wire 7 is connected to the molybdenum foil 6, with the other end of the external lead wire 7 being drawn out of the container. Power is supplied to the heat generation element 2 from the other end of the external lead wire 7 drawn out of the container. The two end portions of the container 3 are fused and bonded to form sealed portions 6, and an inert gas 11 is sealed inside the container 3. The molybdenum foil 6 is embedded in each of the sealed portions 8 formed on the two ends of the container 3.

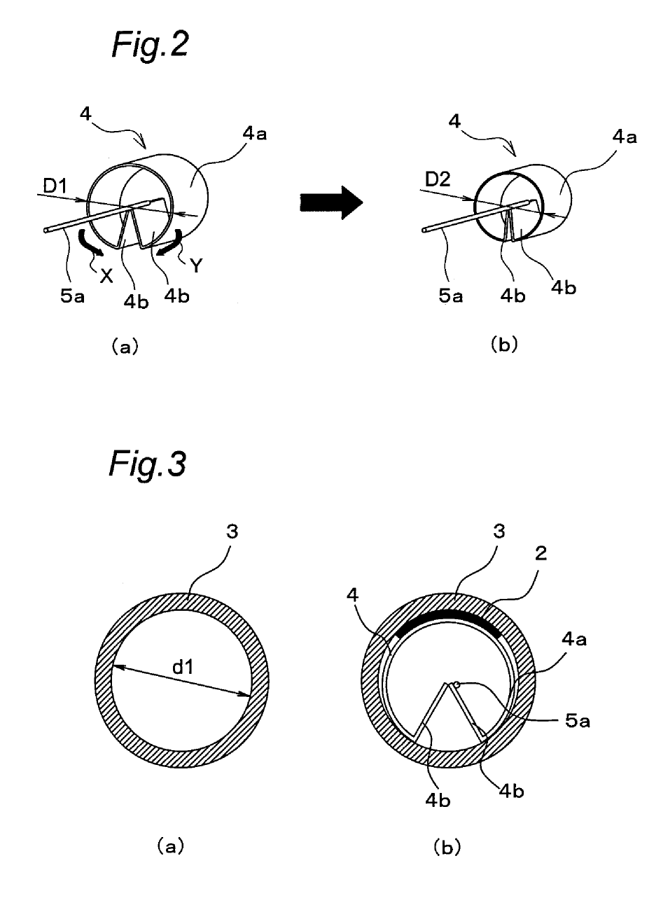

Referring to FIGS. 2 and 3, a holding method for the heat generation element 2 by the holder 4 in the heat generation unit 1 of embodiment 1 will be described. FIG. 2 is views describing a contracting operation at the time when the holder 4 in the heat generation unit 1 of embodiment 1 is pressed. FIG. 3 is cross-sectional views showing a holding state of the heat generation element 2 by the container 3 and the holder 4.

In FIG. 2, the portion (a) shows a pre-regulated state before the holder 4 is pressed, and the portion (b) shows a regulated state after the holder 4 has been pressed. The holder 4 is prepared by forming a molybdenum plate member into a cylindrical shape, with the two end portions thereof being bent inward. That is, the holder 4 is configured by an arc portion 4a and two end portions 4b. The two end portions 4b are structured so that the tip portions thereof are made in contact with each other so as to be movable substantially in the center portion of the arc portion 4a. In this manner, the holder 4 has an arc shape with one portion of the cylinder being omitted on the cross section of the cylinder in a direction orthogonal to the center axis of the cylinder. Moreover, an inner lead wire 5a is electrically connected to the vicinity of the ti portion of one of the two ends 4b.

The holder 4 prior to the regulated state, as shown in the portion (a) of FIG. 2, has an elastic force in its circumferential directions (directions indicated by arrows X and Y in the portion (a) of FIG. 2; therefore, when the holder 4 is pressed from the outside, it contracts and an outer diameter thereof becomes smaller from D1 to D2 (D2<D1). The portion (b) of FIG. 2 shows the holder 4 in the pressed and contracted state (regulated state).

The portion (a) of FIG. 3 shows a cross-sectional shape of the container 3 having the cylindrical shape in its center portion, taken in a direction orthogonal to the longitudinal direction, and the inner diameter in the center portion of the container 3 is d1. The portion (b) of FIG. 3 is a cross-sectional view showing a state in which the holder 4 is attached to the container 3 shown in the portion (a) of FIG. 3, with the heat generation element 2 being sandwiched between the inner wall face of the container 3 and the outer face of the holder 4.

By pressing the holder 4 so as to move the two ends 4b closer to each other, the outer diameter D1 of the holder 4 is made smaller to D2. The holder 4, with its diameter being made smaller to D2, is disposed at a predetermined position inside the container 3 so that the heat generation element 2 is sandwiched and secured.

In the heat generation unit 1 of embodiment 1, the container 3 is formed to have the inner diameter smaller than the outer diameter D1 of the holder 4 in the pre-regulated state, and also larger than the outer diameter D2 of the holder 4 in the regulated state (D1≧d1>D2).

In the heat generation unit 1 of embodiment 1, the holder 4 in the pre-regulated state is pressed from the outside to be formed into a regulated state and made smaller than the inner diameter d1 of the container 3, and is disposed at the predetermined position inside the container, and by releasing the regulation from the holder 4, the holder itself expands by the elastic force of the holder 4 so that it is secured to the inside of the container together with the heat generation element 2 (see the portion (b) of FIG. 3). It should be noted that, in embodiment 1, the outer face shape of the arc portion 4a of the outer circumferential face of the holder 4 is preferably made substantially the same as the inner wall shape of the container 3.

As described above, since the outer diameter D1 of the holder 4 in the pre-regulated state is made greater than the inner diameter d1 of the container 3, the holder 4 is kept in an expanding state inside the container 3 by its elastic force as shown in the portion (b) of FIG. 3. In this expanding state, the outer face of the holder 4 presses the heat generation element 2 onto the inner wall face of the container 3 so that the heat generation element 2 is made into a sandwiched and adhered state. Therefore, the heat generation unit 1 of embodiment 1 provides a structure in which the heat generation element 2 is sandwiched by the outer face of the wider arc portion 4a of the holder 4 and the inner wall face of the container 3. Accordingly, the heat generation unit 1 makes it possible to set the contact area of the holder 4 with the heat generation element 2 wider so that this holding method provides a uniform holder without causing a partial heat generation.

In the heat generation unit 1 of embodiment 1, molybdenum is used as the material for the holder 4; however, any material may be used as long as it has elasticity and conductivity, and in addition to molybdenum, examples thereof include tungsten and a stainless alloy.

As described above, the heat generation unit 1 of embodiment 1 has a structure in which, by using an elastic force of the holder 4, the heat generation element 2 is sandwiched by the inner wall face of the container 3 and the outer face of the holder 4. Consequently, the heat generation element 2 is held by the holder 4 without causing partial heat generation so that it is possible to provide an electrically reliable connection state.

Moreover, in the heat generation unit 1 of embodiment 1, heat which is generated by the heat generation element 2 is transmitted to the holder 4 in this structure, since the holder 4 is made in contact with the container 3, the heat transmitted from the heat generation element 2 is released in the container 3. With this arrangement, it is possible to prevent an excessive temperature rise in the holder 4 and the power supply members 5 caused by the heat from the heat generation element 2. As a result, the heat generation unit 1 of embodiment 1 makes it possible to prevent degradation of the elastic force in the holder 4, and consequently to prolong the service life of the heat generation unit.

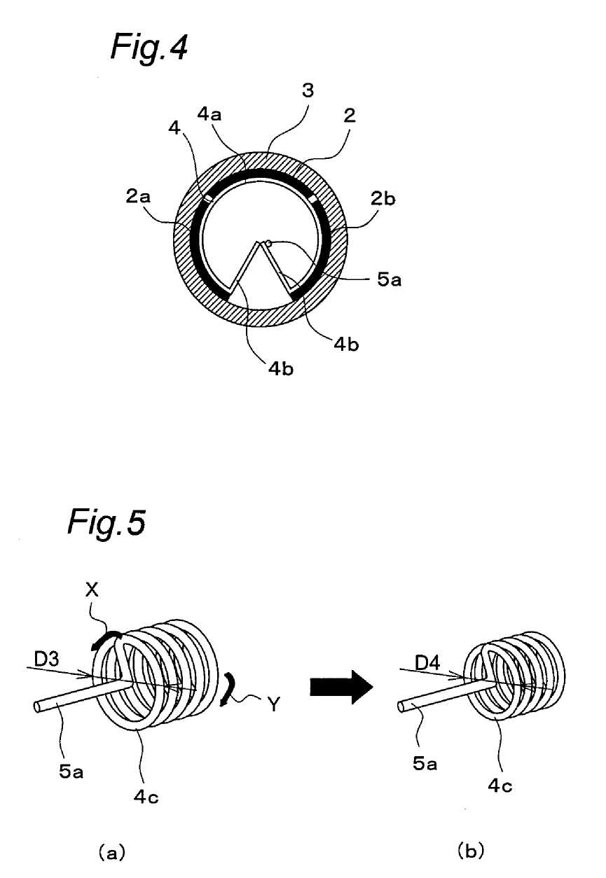

FIG. 4 is a cross-sectional view showing a state in which a plurality of heat generation elements 2, 2a and 2b are sandwiched between the holder 4 and the inner wall face of the container 3 by using the holder 4 shown in FIG. 2 in the heat generation unit of embodiment 1 in this manner, by using the holder 4 shown in FIG. 2, it becomes possible to hold the plurality of heat generation elements 2, 2a and 2b in a manner so as tomb tightly made in contact with the inner wall face of the container 3. As shown in FIG. 4, by holding the plurality of heat generation elements 2, 2a and 2h inside the container 3, it becomes possible to provide a heat generation unit that can provide a heat source capable of heating a wider range.

FIG. 5 is views showing another structure of the holder in the heat generation unit 1 of embodiment 1. The portion (a) of FIG. 5 shows a holder 4c in a pre-regulated state, and the portion (b) of FIG. 5 shows the holder 4c in the regulated state. The holder 4c, shown in FIG. 5, is prepared by forming a molybdenum wire into a spiral shape. In a pre-regulated state (in a state where the outer diameter of the holder is set to D3) as a single product of the holder 4c shown in the portion (a) of FIG. 5, by twisting the holder 4c in such a direction as to make the outer shape of the holder 4c smaller (in a winding direction of the spiral: directions indicated by arrows X and Y in FIG. 5), the holder 4c is formed into a regulated state with the outer diameter being made smaller so that the outer diameter D4 is set to (D4<D3). Upon attaching the holder 4c in the regulated state as shown in the portion (b) of FIG. 5 to the above-mentioned container (inner diameter: d1) as shown in the portion (a) of FIG. 3, the inner diameter d1 of the container 3 is not more than the outer diameter D3 of the holder 4c in the pre-regulated state so as to be made greater than the outer diameter D4 of the holder 4c (D3≧d1>D4) in the regulated state.

In the case of the molding member 4c shown in FIG. 5, the holder 4c in the regulated state, which has been twisted (in the winding direction of the spiral) in such a direction as to make the outer diameter smaller, is disposed in a predetermined position inside the container, and by releasing the regulation, the spiral portion of the holder 4c is expanded by the elastic force of the holder 4c so that it is secured to the inside of the container 3 together with the heat generation element 2. It should be noted that, in the present embodiment, the outer circumferential portion of the spiral portion of the holder 4c is preferably made to have substantially the same shape as the shape of the inner wall face of the container 3.

As described above, since the outer diameter D3 of the holder 4c in the pre-regulated state is made to be wider than the inner diameter d1 of the container 3, the holder 4c is allowed to expand by the elastic force of its spiral portion inside the container 3. Thus, the outer circumferential portion of the spiral portion of the holder 4c presses the heat generation element 2 onto the inner wall face of the container 3 so as to be sandwiched and adhered therebetween. Since the spiral portion of the holder 4c is formed so as to have a wider outer circumferential portion in its expanding and contracting directions; thus, the heat generation element 2 is sandwiched by the wide outer circumferential portion of the spiral portion and the inner wall face of the container 3. As a result, since the contact area of the holder 4c to the heat generation element 2 can be made wider, the holding method provides a uniform holder without causing a partial heat generation, and also makes it possible to ensure the connection.

Since the holder 4c, shown in FIG. 5, is formed into a spiral shape, each of the spiral portions that sandwich the heat generation element 2 has a spring property in a radiating direction. Therefore, in comparison with the holder 4 made by forming a plate member into a cylindrical shape, shown in FIG. 2, the holder 4c has a structure in which the heat generation element 2 is reliably sandwiched between the holder 4 and the inner wall face of the container 3 without requiring high dimensional precision.

It should be noted that, by using the holder 4c shown in FIG. 5, a plurality of heat generation elements can be reliably sandwiched between the holder 4c and the inner wall face of the container, as shown in FIG. 4 in this manner. It becomes possible to easily hold a plurality of heat generation elements inside the container 3 so that it becomes possible to provide a heat generation unit that can achieve a heat source capable of heating a wider range.

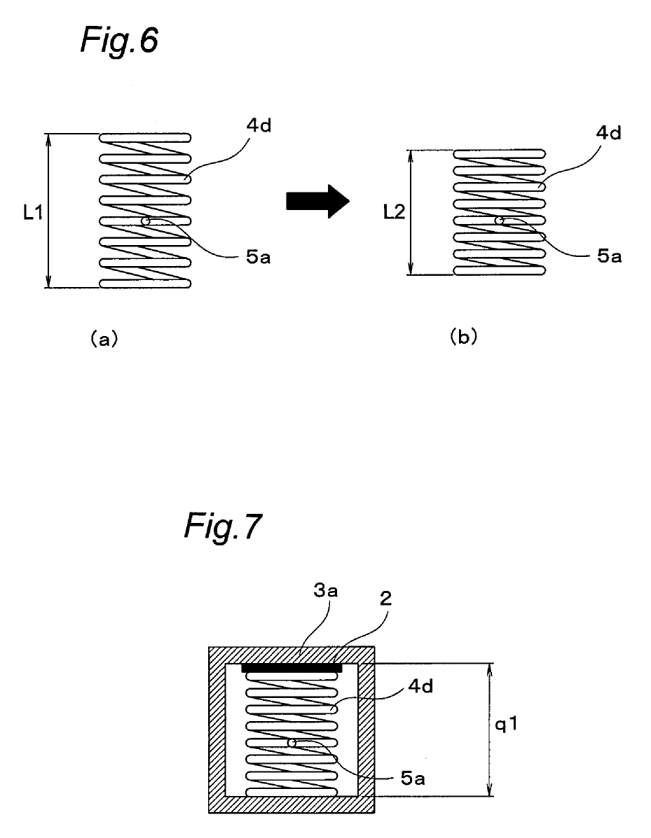

FIGS. 6 and 7 are views that show still another structure of the holder in the heat generation unit 1 of embodiment 1. In the heat generation unit shown in FIGS. 6 and 7, the cross-sectional shape of the center portion thereof, taken in a direction orthogonal to the longitudinal direction of the container 3a, is a rectangular shape, that is, for example, a square shape. The portion (a) of FIG. 6 shows a holder 4d in a pre-regulated state, and the portion (b) of FIG. 6 shows the holder 4d in a regulated state. FIG. 7 shows a state in which the holder 4d is attached to the inside of the container 3a having a square shape cross-section so that a heat generation element 2 is held therein. The holder 4d, shown in FIGS. 6 and 7, is prepared by forming a molybdenum wire into a spiral shape so as to form a coil spring, and structured so that the expanding and contracting directions of the coil spring are coincident with directions orthogonal to the longitudinal direction of the container 3a. In the holder 4d of FIG. 6, supposing that the free length of the holder 4d in the pre-regulated state, as shown in the portion (a) of FIG. 6, is L1, and that the compressed length L2 of the holder 4d in the regulated state, as shown in the portion (b) of FIG. 6, is L2, as well as supposing that the length between the holding inner wall faces (upper and lower inner wall faces in FIG. 7) of the container 3a shown in FIG. 7 is q1, a relationship indicated by L1>q1≧L2 is satisfied.

In the case of the holder 4d shown in FIGS. 6 and 7, the holder 4d is compressed into a regulated state, and disposed at a predetermined position inside a container, and by releasing the regulation, the coil spring of the holder 4d is allowed to expand by the elastic force of the holder 4d so that the coil spring is secured to the inside of the container together with the heat generation element 2 it should be noted that, in this embodiment, faces which are formed by the two ends of the coil spring of the holder 4d in the expanding/contracting direction, and the holding inner wall faces (upper and lower inner wall faces in FIG. 7) of the container 3 are preferably formed into substantially the same shape, that is, substantially the same flat face.

As described above, since the free length L1 of the holder 4d in the pre-regulated state is formed to be greater than the length q1 between the holding inner wall faces of the container 3a, the holder 4d is allowed to expand by the elastic force of the coil spring inside the container 3a. Thus, the two ends of the coil spring of the holder 4c1 press the heat generation element 2 onto one of the holding inner wall faces of the container 3a to be made into a sandwiched and adhered state. In this case since the two end portions of the coil spring in the holder 4d are formed so as to have large sizes, the heat generation element 2 is sandwiched between the wide two end portions and the inner wall face of the container 3a. As a result, the contact area of the holder 4d relative to the heat generation element 2 can be made larger so that it is possible to prevent a partial high-temperature state, and also to provide a holding method capable of ensuring the connection.

In the holder 4d shown in FIGS. 6 and 7, a description has been given by exemplifying a container having a square cross-sectional shape taken in a direction orthogonal to the longitudinal direction; however, the present invention is not limited to this shape, and any shape may be adopted as long as it is more uniformly held by the two end portions of the coil spring.

Moreover, by using the holder 4d shown in FIG. 6, it is possible to reliably sandwich a plurality of heat generation elements between the holder 4d and the inner wall faces of the container 3. For example, by using an arrangement in which both of the two end portions of the holder 4d are used for holding heat generation elements, heat radiation can be exerted from the two faces of the container 3. Accordingly, it becomes possible to provide a heat generation unit that can provide a heat source capable of heating a wider range.

### Embodiment 2

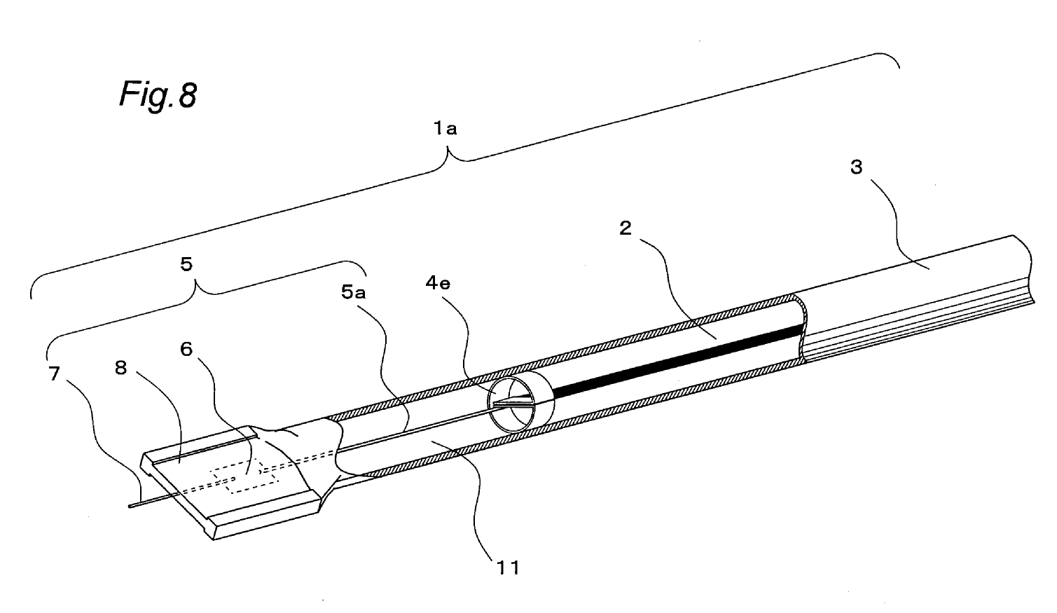

Referring to FIGS. 8 to 10, a heat generation unit according to embodiment 2 of the present invention will be described below. FIG. 8 is a perspective view showing a structure of a heat generation unit 1a according to embodiment 2. In FIG. 8, since the heat generation unit 1a has an elongated shape with two ends in a longitudinal direction having the same structure, only one of the ends is shown, with the other end being omitted from the drawing.

The heat generation unit 1a of embodiment 2 differs from the heat generation unit 1 of embodiment 1 in the structure of the holder, and the other portions are the same as those of the heat generation unit 1 of embodiment 1. Therefore, in the description of embodiment 2, components having the same functions and structures are indicated by the same reference numerals, and the descriptions of embodiment 1 will be applied to the descriptions thereof.

In the heat generation unit 1a of embodiment 2, a film-sheet-shaped heat generation element 2 is disposed inside a container 3, and the heat generation element 2 is held in a predetermined position inside the container by a holder 4e having elasticity and conductivity. Power supply members 5 are configured by an inner lead wire 5a, molybdenum foil 6 and an external lead wire 7. One end of the inner lead wire 5a is electrically connected to the holder 4e, and the other end of the inner lead wire 5a is electrically connected to the molybdenum foil 6 that is embedded in each sealed portion 8. One end of the external lead wire 7, drawn out of the container, is connected to the molybdenum foil 6. Power is supplied to the heat generation element 2 from the external lead wire 7. The two end portions of the container 3 are fused and bonded in the sealed portions 8, and an inert gas 11 is sealed inside the container.

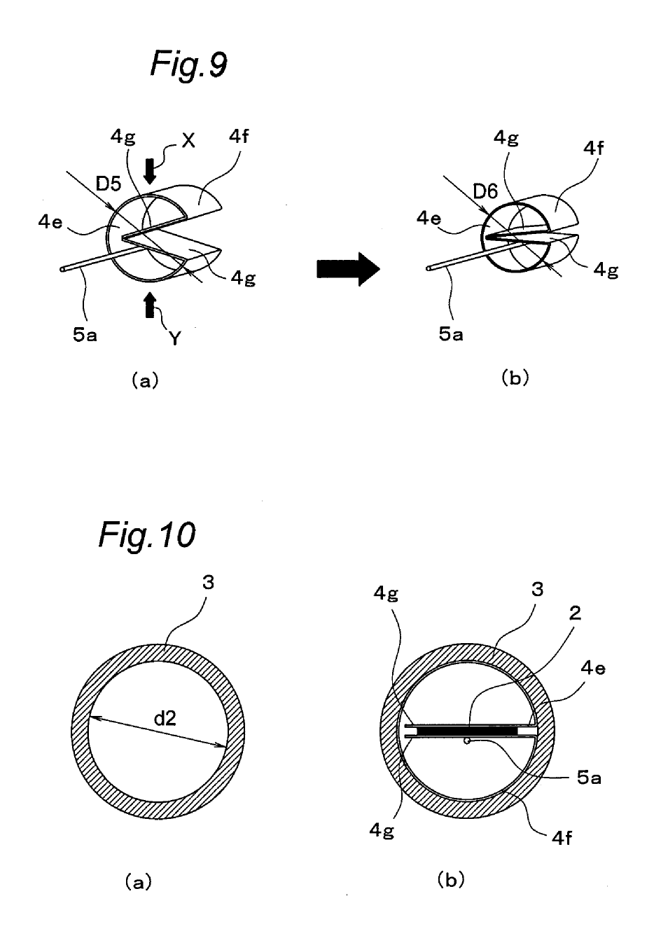

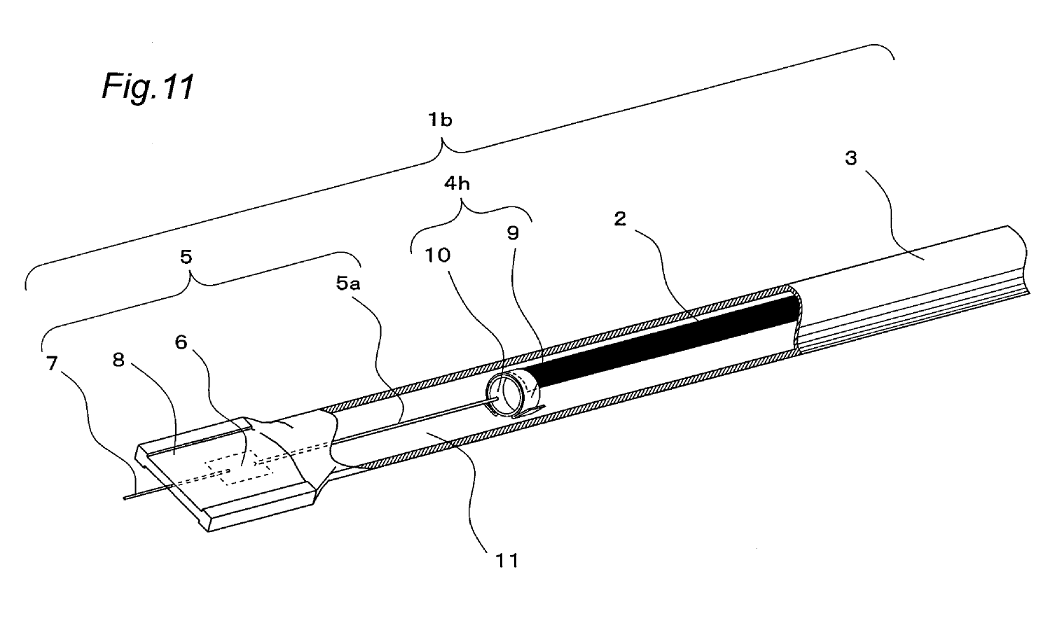

Referring to FIGS. 9 and 10, a holding method for the heat generation element 2 by the holder 4e in the heat generation unit 1a of embodiment 2 will be described. FIG. 5 is views describing a contracting operation at the time when the holder 4e in the heat generation unit 1a of embodiment 2 is pressed. FIG. 10 is cross-sectional views showing a sandwiched and held state of the heat generation element 2 by the holder 4e of FIG. 10.

In FIG. 9, the portion (a) shows a pre-regulated state before the holder 4e is pressed, and the portion (b) shows a regulated state after the holder 4e has been pressed. The holder 4e is provided with an arc portion 4f prepared by forming a molybdenum plate member into an arc shape, and sandwiching portions 4g that are formed by bending the two end portions of the arc portion 4f inward of the arc portion 4f. That is, the holder 4e has a shape in which one portion of the arc is omitted from a cross section orthogonal to the center axis of the cylinder portion. The sandwiching portions 4g, directed to the inner side from the two ends of the arc portion 4f, are formed into flat plate shapes, each having a flat face. The length (width) in a direction orthogonal to the longitudinal direction of the heat generation element 2 is set to a length substantially close to the diameter of the arc portion 4f within such a range as not to allow the tip to come into contact with the inner wall face of the arc portion 4f. The pre-regulated state in the portion (a) of FIG. 5 shows a state in which the respective tip portions of the sandwiching portions 4g are made in contact with each other. Moreover, in one of the sandwiching portions 4c, an inner lead wire 5a is electrically connected to the vicinity of the center axis thereof.

The holder 4e in the pre-regulated state, as shown in the portion (a) of FIG. 9, is contracted when pressed from the outside (in directions indicated by arrows X and Y in the portion (a) of FIG. 9) so that the outer diameter becomes smaller from D5 to D6 (D6<D5). The portion (b) of FIG. 9 shows the contracted state (regulated state) of the holder 4e.

The portion (a) of FIG. 10 shows a cross-sectional shape orthogonal to the longitudinal direction of the container 3 in its center portion. The inner diameter in the center portion of the container 3 is represented by d2. The portion (h) of FIG. 10 is a cross-sectional view showing a state in which the holder 4e is attached to the container 3 shown in the portion (a) of FIG. 10, with the heat gene rat ion element 2 being sandwiched by the sandwiching portions 4g inside the container.

By pressing the holder 4e to be contracted, the outer diameter D5 of the holder 4e is made smaller to D6. The holder 4e in a state having a smaller size is disposed at a predetermined position in the container 3 so that the heat generation element is sandwiched and secured.

In the heat generation unit 1a of embodiment 2, the inner diameter d1 of the container 3 is set to not more than the outer diameter D5 of the holder 4e in the pre-regulated state, and is also made larger than the outer diameter D6 of the holder 4e in the regulated state (D5≧d2>D6).

In the heat generation unit 1a of embodiment 2, with the heat generation element 2 being sandwich by the sandwiching portions 4g, the holder 4e is pressed from the outside, and made into the regulated state having a size smaller than the inner diameter d2 of the container 3, and is then disposed at a predetermined position inside the container. Thereafter, by releasing the regulation imposed to the holder 4e, the holder itself is allowed to expand by the elastic force of the holder 4e so that the holder 4e is secured inside the container, with the heat generation element 2 being sandwiched by the sandwiching portions 4g (see the portion (h) of FIG. 10).

As described above, since the outer diameter D5 of the holder 4e in the pre-regulated state is made larger than the inner diameter d2 of the container 3, the holder 4e is kept in an expanding state by its elastic force inside the container, as shown in the portion (b) of FIG. 10. Therefore, the holder 4e is reliably secured inside the container, with the heat generation element 2 being sandwiched by the flat faces of the sandwiching portions 4g of the holder 4e and reliably held at a predetermined position inside the container. Therefore, in the heat generation unit 1a of embodiment 2, since the holding process is carried out by the sandwiching portions 4g, each having a wide flat face, of the holder 4e, the contact area of the holder 4e with the heat generation element 2 can be made larger so that it is possible to provide a holding method capable of providing a connection with high reliability, with partial heat generation being prevented in the holder of the heat generation element 2.

Moreover, in the heat generation unit 1a of embodiment 2, since the outer face of the arc portion 4f of the holder 4e is made in contact with the inner wall face of the container 3, heat in the holder 4e, transmitted from the heat generation element 2, is transferred to the container 3 and released therefrom. As a result, since the holder 4e is kept in a cooled state by the container 3, it is possible to prevent a reduction in the elastic force of the holder 4e, and thereby achieve a long service life.

Moreover, since the heat generation element 2 is sandwiched in a bridged state, in which the heat generation element 2 does not come into contact with the container 3 inside the holder 4e, no heat is directly transmitted to the container 3 from the heat generation element 2. Accordingly, a highly-efficient heat radiating structure from the heat generation element 2 can be obtained.

As described above, according to the heat generation unit 1a of embodiment 2, since the heat generation element 2 is indirectly held through the container 3 and the holder 4e, with the heat generation element 2 not being directly made in contact with the container 3, the heat generation element 2 is allowed to have a quick temperature rise, thereby it becomes possible to provide a heat generation unit having a fast response speed.

Moreover, in the heat generation unit 1a of embodiment 2, since the holder 4e is maintained in contact with the container 3, the holder 4e is allowed to efficiently radiate heat so that the material to be used for the holder 4e can be selected from a wide range of candidates. For example, in addition to the materials, such as molybdenum, tungsten and stainless alloys, described in the embodiment 1, metals such as aluminum and nickel or materials having a shape memory property may also be used.

### Embodiment 3

Referring to FIGS. 11 to 17, a heat generation unit according to embodiment 3 of the present invention will be described below. FIG. 11 is a perspective view showing a structure of a heat generation unit 1b according to embodiment 3. In FIG. 11, since the heat generation unit 11b has an elongated shape with two ends in a longitudinal direction having the same structure, only one of the ends is shown, with the other end being omitted from the drawing.

The heat generation unit 1b of embodiment 3 differs from the heat generation unit 1 of embodiment 1 in the structure of the holder, and the other portions are the same as those of the heat generation unit 1 of embodiment 1. Therefore, in the description of embodiment 3, components having the same functions and structures are indicated by the same reference numerals, and the descriptions of embodiment 1 will be applied to the descriptions thereof.

In the heat generation unit 1b of embodiment 3, a film-sheet-shaped heat generation element 2 is placed inside a container 3, and the heat generation element 2 is held in a predetermined position inside the container by a holder 4h. Power supply members 5 are configured by an inner lead wire 5a, molybdenum foil 6 and an external lead wire 7. One end of the inner lead wire 5a is electrically connected to the holder 4e, and the other end of the inner lead wire 5a is electrically connected to the molybdenum foil 6 that is embedded in each sealed portion 8. One end of the external lead wire 7, drawn out of the container, is connected to the molybdenum foil 6. Power is supplied to the heat generation element 2 from the external lead wire 7. The two end portions of the container 3 are fused and bonded in the sealed portions 8, and an inert gas 11 is sealed inside the container.

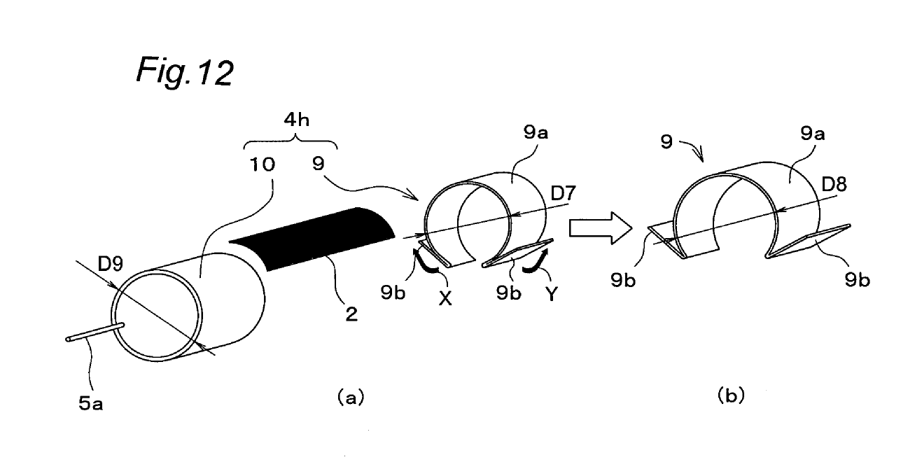

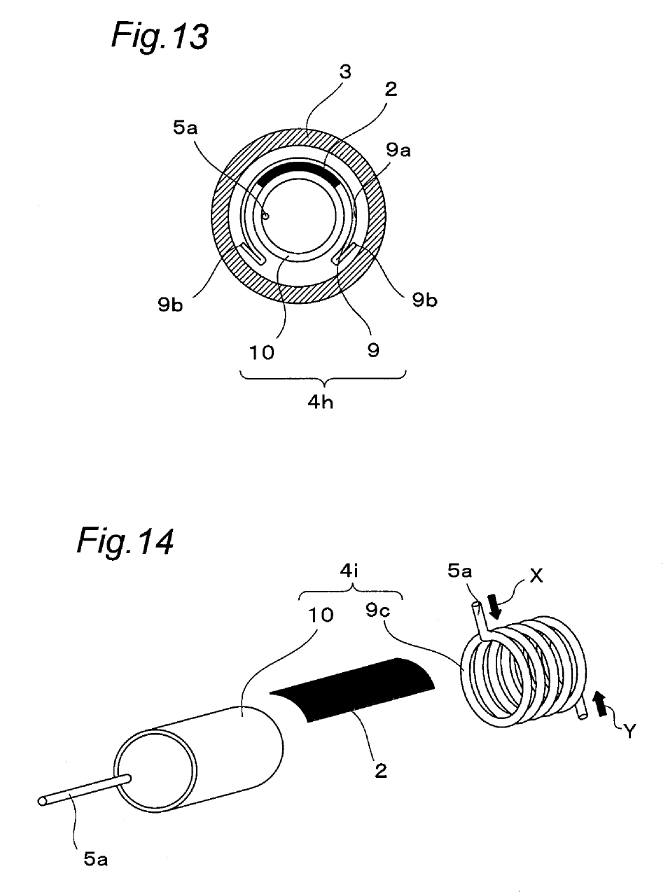

Next, referring to FIGS. 12 and 13, a holding method for the heat generation element 2 by the holder 4h in the heat generation unit 1b of embodiment 3 will be described. The portion (a) of FIG. 12 is an exploded perspective view showing the structure of the holder 4h in the heat generation unit 1b of embodiment 3, and the portion (b) of FIG. 12 is a view showing a state in which one portion of the holder 4h has been regulated.

FIG. 13 is a cross-sectional view showing a held state of the heat generation element 2 by the holder 4h.

As shown in the portion (a) of FIG. 12, the holder 4h in the heat generation unit 1b of embodiment 3 is configured by a first holding member 9 having elasticity and conductivity and a cylindrical second holding member 10 that is sandwiched by the first holding member 9. The first holding member 9 is provided with an arc portion 9a formed by bending a molybdenum plate member into an arc shape and bent portions 9b that are formed by bending the two ends of the arc portion 9a outward from the arc shape. Moreover, the second holding member 10 is made of molybdenum and has a cylindrical shape. An inner lead wire 5a is electrically connected to the inner wall face of the cylindrical portion of the second holding member 10.

By moving the bent portions 9b on the two sides of the first holding member 9 of the holder 4h in circumferential directions (directions indicated by arrows X and Y in the portion (a of FIG. 12) in a manner so as to be expanded, the inner diameter D7 (inner diameter in a pre-regulated state) of the first holding member 9 is set to be inner diameter 28 (inner diameter in a regulated state) as shown in the portion (b) of FIG. 9 (D8>D7).

Moreover, supposing that the outer diameter of the second holding member 10 is represented by D9, the outer diameter D9 of the second holding member 10 is made to be larger than the inner diameter D7 of the first holding member 9 in the pre-regulated state, and also to be smaller than the inner diameter D8 in the regulated state (D8>D9≧D7).

FIG. 13 is a cross-sectional view showing a state in which the heat generation element 2 is held by the holder 4h configured by the first holding member 9 and the second holding member 10. As shown in FIG. 13, the holding element 2 is sandwiched between the first holding member 9 and the second holding member 10.

In the heat generation unit 1b of embodiment 3, the heat generation element 2 is disposed between the inner circumferential face of the first holding member 9 and the outer circumferential face of the second holding member 10, with the bent portions 9b on the two sides of the first holding member 9 being mutually moved outward in the circumferential directions (directions indicated by arrows X and Y in the portion (a) of FIG. 12). Moreover, by releasing the regulation to the bent portions 9b of the first holding member 9, the first holding member 9 is attached to the second holding member 10 with the heat generation element 2 being interposed therebetween. As a result, the heat generation element 10 is reliably sandwiched by the first holding member 9 and the second holding member 10.

As described above, since the first holding member 9, formed by an arc-shaped plate member with elasticity, is structured to sandwich and hold the cylindrical second holding member 10 so that the heat generation element 2 is reliably sandwiched and held by the inner circumferential face of the first holding member 9 and the outer circumferential face of the second holding member 10. Therefore, in the heat generation unit 1b of embodiment 3, the contact area with the heat generation element 2 can be set to a larger area so that it is possible to prevent the holder from causing a partial high temperature, and consequently to provide a connection with high reliability.

As described above, since the heat generation unit 1b of embodiment 3 has the structure in which the heat generation element 2 is sandwiched between the first holding member 9 and the second holding member 10 that are components of the holder 4h by the elastic force of the first holding member 9, it is possible to reliably connect the heat generation element 2 by using a uniform pressure.

Moreover, since the holder 4h in the heat generation unit 1b of embodiment 3 is kept in anon-contact state from the container 3, no thermal conductivity is exerted from the holder 4h to the container 3. Therefore, the heat generation element 2 is allowed to have a quick temperature rise so that it becomes possible to provide a heat generation unit having a fast response speed.

In embodiment 3, the second holding member 10 is described as a cylindrical shape with a space therein; however, the second holding member 10 may be formed into a column shape with a solid inside portion. However, in the case where the holder 4h is formed into the column shape, since the thermal capacity becomes greater, the response speed of the heat generation element 2 becomes slower. Therefore, materials having high thermal conductivity need to be selected as the material for the second holding member 10.

Moreover, embodiment 3 has been described by exemplifying the structure in which the inner lead wire 5a is electrically connected to the second holding member 10; however, the inner lead wire 5a may be connected to the first holding member 9. In such a structure, since the first holding member 9 is structured to supply power to the heat generation element 2, the material for the first holding member 9 is limited to a conductive material, while the second holding member 10 is not limited to the conductive material.

FIG. 14 is a perspective view showing another mode of the holder in the heat generation unit 1b of embodiment 3. A holder 4i shown in FIG. 14 is configured by a first holding member 9c and a second holding member 10. The first holding member 9c is prepared by forming a molybdenum wire into a spiral shape. The second holding member 10, which has the same structure as that of the second holding member 10 shown in FIG. 12, is made of molybdenum and has a cylindrical shape.

The first holding member 9 has an elastic structure in which, by applying pressures in opposing directions to the two ends relative to the winding direction of the spiral portion, the inner diameter of the first holding member 9c can be made larger. In the same manner as in the first holding member 9 of the holder 4h shown in FIG. 12, by making the inner diameter of the first holding member 9c shown in FIG. 14 larger, the second holding member 10 and the heat generation element 2 are inserted therein so that the heat generation element 2 is sandwiched between the inner circumferential face of the first holding member 9c and the outer circumferential face of the second holding member 10.

Since the first holding member 9c allows individual spiral portions formed into a spiral shape to exert a spring property, the heat generation element 2 is reliably sandwiched between the first holding member 9c and the outer circumferential face of the second holding member 10, without the necessity of having higher dimensional precision in comparison with the first holding member 9 formed into an arc shape as shown in FIG. 12.

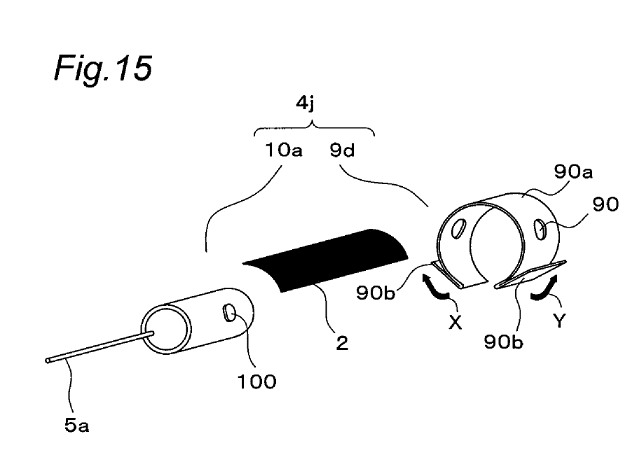

FIG. 15 is a perspective view showing still another mode of the holder in the heat generation unit 1b of embodiment 3. A holder 4j shown in FIG. 15 is configured by a first holding member 9d and a second holding member 10a. The first holding member 9d is prepared by forming a molybdenum plate member into an arc shape. The second holding member 10a is made of molybdenum and has a cylindrical shape, and an inner lead wire 5a is electrically connected to its inner circumferential face.

The first holding member 9d is configured by an arc portion 90a formed into an arc shape and bent portions 90b that are bent outward of the arc shape from the two sides of the arc portion 90a. A plurality (two in FIG. 15) of through holes 90 are formed on the arc face of the arc portion 90a. In a sandwiched state of the heat generation element 2, these through holes 90 are formed at positions on the two sides where heat generation element 2 is not located. On the outer circumferential face of the second holding member 10a, protrusions 100 are formed on positions corresponding to the through holes 90 of the first holding member 9d in the sandwiched state of the heat generation element 20.

In the same manner as in the first holding member 9 of the holder 4h shown in FIG. 12, the holder 4j shown in FIG. 15 has a structure in which the bent portions 90b of the first holding member 9d are expanded to make the inner diameter of the first holding member 9d larger, the second holding member 10a and the heat generation element 2 are inserted therein so that the heat generation element 2 is sandwiched between the inner circumferential face of the first holding member 9d and the outer circumferential face of the second holding member 10a. In this case, the first holding member 9d is placed so as to sandwich the second holding member 10a in such a manner as to allow the through holes 90 of the first holding member 9d and the protrusions 100 of the second holding member 10a to be fitted to each other.

In the holder 4j shown in FIG. 15, since the protrusions 100 of the second holding member 10a are fitted to the through holes 90 of the first holding member 9d, the protrusions 100 of the second holding member 10a serve as wedges relative to the heat generation element 2 and the first holding member 9d so that the heat generation element 2 can be sandwiched and held by the holder 4j more firmly. Moreover, in the case where a plurality of the through holes 50 and a plurality of the corresponding protrusions 100 are formed, it is also possible to regulate the position of the heat generation element 2; however, even in a case where only one set of the through hole and the protrusion is formed, a function for holding the heat generation element 2 firmly as the holder is exerted.

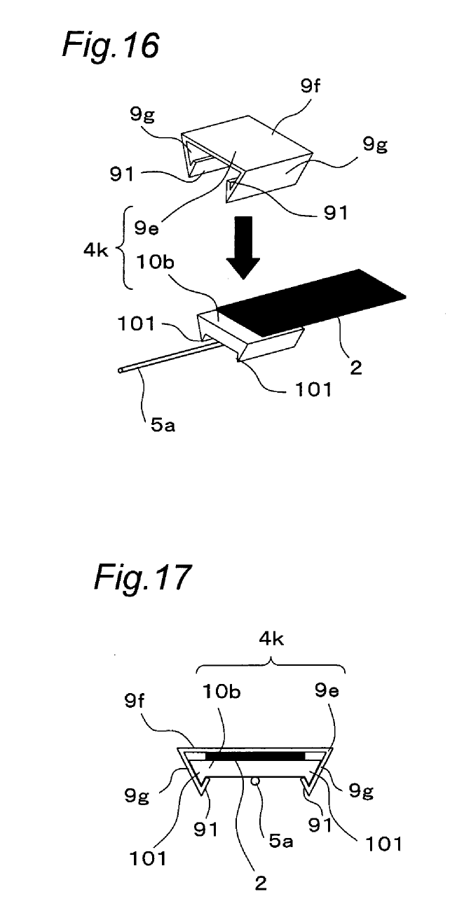

FIG. 16 is a perspective view showing still another mode of the holder in the heat generation unit 1b of embodiment 3. A holder 4k shown in FIG. 16 is configured by a first holding member 9e and a second holding member 10b. The first holding member 9e, which is made of a molybdenum plate member, is provided with a flat-face portion 9f having a flat face and slanting face portions 9g that protrude toward the second holding member 10b (downward in FIG. 16) from the two sides thereof. The slanting face portions 5g, formed so as to be directed from the two sides of the flat-face portion 9f, are shaped so as to be gradually narrowed toward the tips thereof, and a hook portion 91 that is bent inward is formed on each of the protruded ends. That is, the first holding member 9e is formed into a trapezoidal shape with the flat-face portion 9f and the slanting face portions 9b on the two sides. Each of the slanting face portions 9g of the first holding member 9e has elasticity and is structured to recover its shape even after it has been pushed and expanded.

On the other hand, the second holding member 10b is made of molybdenum, and has a trapezoidal shape in its cross section orthogonal to the longitudinal direction of the heat generation element 2. That is, the second holding member 10b has such a shape as to be made tightly in contact with the inner side of the first holding member 9e and engaged therewith. Moreover, protruding portions 101 are formed on the two sides of the upper side (on the lower face in FIG. 16) of the trapezoidal shape of the second holding member 10b, and structured to be engaged with the hook portions 91 of the first holding member 9e. An inner lead wire 5a is electrically connected to the lower face of the second holding member 10b.

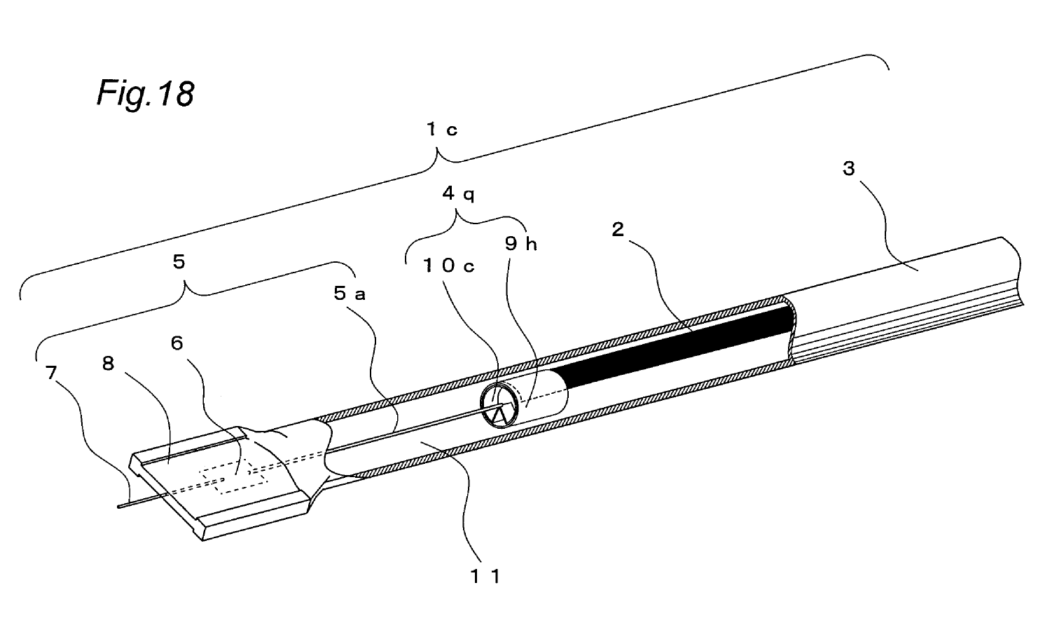

FIG. 17 is a cross-sectional view showing a state in which the first holding member 9e is attached to the second holding member 10b so that the heat generation element 2 is held therein. The heat generation element 2 is sandwiched by the flat-face portion 9f the first holding member 9e and the flat face (the upper face in FIG. 17) of the second holding member 10b that opposes this flat-face portion 9f, and held therebetween.

In the holding method of the heat generation element 2 by using the holder 4k shown in FIG. 17, in a state where the heat generation element 2 is placed on the flat face (upper face) of the second holding member 10b, the slanting face portions 9g of the first holding member 9e are opened outward, and put on the second holding member 10b so as to be attached thereto. At this time, the hook portions 91 of the first holding member 9e are engaged with the protruding portions 101 of the second holding member 10b. In this manner, the first holding member 9e is engaged with the second holding member 10b so as to cover the second holding member 10b from above so that the heat generation element 2 is sandwiched by the flat portions of the holder 4k. Therefore, in the heat generation unit of embodiment 4, the heat generation element 2 is held with higher reliability without causing a partial high temperature at the holder of the heat generation element 2.

It should be noted that, the holder 4k shown in FIGS. 16 and 17 is kept in a non-contact state from the container 3 so that no thermal conduction is exerted from the holder 4k to the container 3. With this structure, heat of the heat generation element 2 is transmitted to the sealed portions 8 through the inner lead wire 5a, and, depending on the specification and structure of the heat generation unit, the sealed portions 8 tend to be subjected to high temperatures to cause a crack in the sealed portions 8, which may lead to a short service life. Therefore, in an attempt to prevent a temperature rise in the sealed portions 8, a heat-radiating block having a heat-radiating function may be effectively formed on the inner lead wire 5a.

Moreover, by providing a coil-shaped spiral portion having elasticity to the inner lead wire 5a, it is possible to provide a structure for absorbing thermal expansion due to the heat generation of the heat generation element 2.

### Embodiment 4

Referring to FIGS. 18 to 22, a heat generation unit according to embodiment 4 of the present invention will be described below. FIG. 18 is a perspective view showing a structure of a heat generation unit 1c according to embodiment 4. In FIG. 18, since the heat generation unit 11c has an elongated shape with two ends in a longitudinal direction having the same structure, only one of the ends is shown, with the other end being omitted from the drawing.

The heat generation unit 1c of embodiment 4 differs from the heat generation unit 1 of embodiment 1 in the structure of the holder, and the other portions are the same as those of the heat generation unit 1 of embodiment 1. Therefore, in the description of embodiment 4, components having the same functions and structures are indicated by the same reference numerals, and the descriptions of embodiment 1 will be applied to the descriptions thereof.

In the heat generation unit 1c of embodiment 4, a film-sheet-shaped heat generation element 2 is placed inside a container 3, and the heat generation element 2 is held in a predetermined position inside the container by a holder 4g. Power supply members 5 are configured by an inner lead wire 5a molybdenum foil 6 and an external lead wire 7. One end of the inner lead wire 5a is electrically connected to the holder 4q, and the other end of the inner lead wire 5a is electrically connected to the molybdenum foil 6 that is embedded in each sealed portion 8. One end of the external lead wire 7, drawn out of the container, is connected to the molybdenum foil 6. Power is supplied to the heat generation element 2 from the external lead wire 7. The two end portions of the container 3 are fused and bonded in the sealed portions B, and an inert gas 11 is sealed inside the container 3.

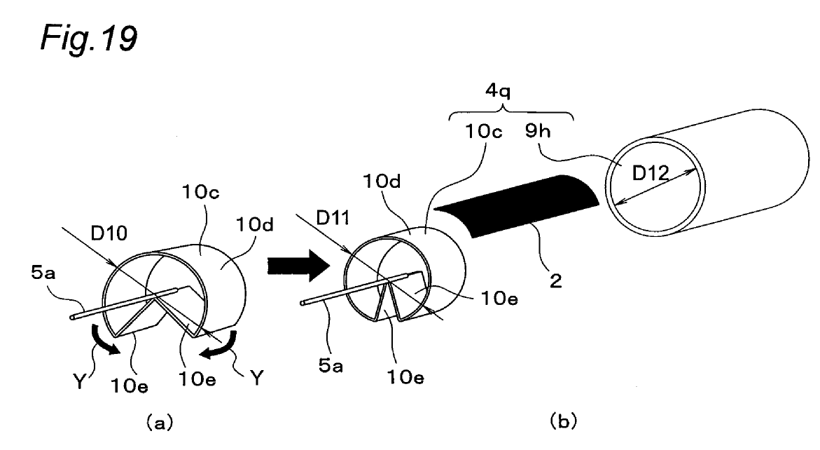

FIG. 19 is views showing a sandwiching and holding method of a heat generation element 2 by the holder 4q in the heat generation unit ic of embodiment 4. The portion (a) of FIG. 19 shows the second holding member 10c in its pre-regulated state, and the portion (b) of FIG. 19 is an exploded perspective view of the holder 4q.

As shown in the portion (b) of FIG. 15, the holder 4q is configured by a cylindrical first holding member 9h and a second holding member 10c to be housed inside the first holding member 9h. The first holding member 9h is made of molybdenum, and has a cylindrical shape with an inner diameter of D12. On the other hand, the second holding member 10c is configured by an arc portion 10d prepared by forming a molybdenum plate member into an arc shape and two end portions 10e formed by bending the two end portions of the arc portion 10d inward of the arc shape. Moreover, an inner lead wire 5a is connected to the inner circumferential face of either one of the two end portions 10e of the second holding member 10c.

In FIG. 19, the portion (a) shows a holding member 10c in a pre-regulated state prior to being pressed from outside, and the portion (b) shows the holding member 10c in a regulated state with the outer diameter thereof being made smaller by the pressure given from outside. Since the second holding member 10c in the pre-regulated state has elastic forces in its circumferential directions (directions indicated by arrows X and Y in FIG. 19), the second holding member 10c is contracted when pressed from outside in the directions indicated by arrows X and Y, with the result that the outer diameter is made smaller from D10 to D11 (D11<D10).

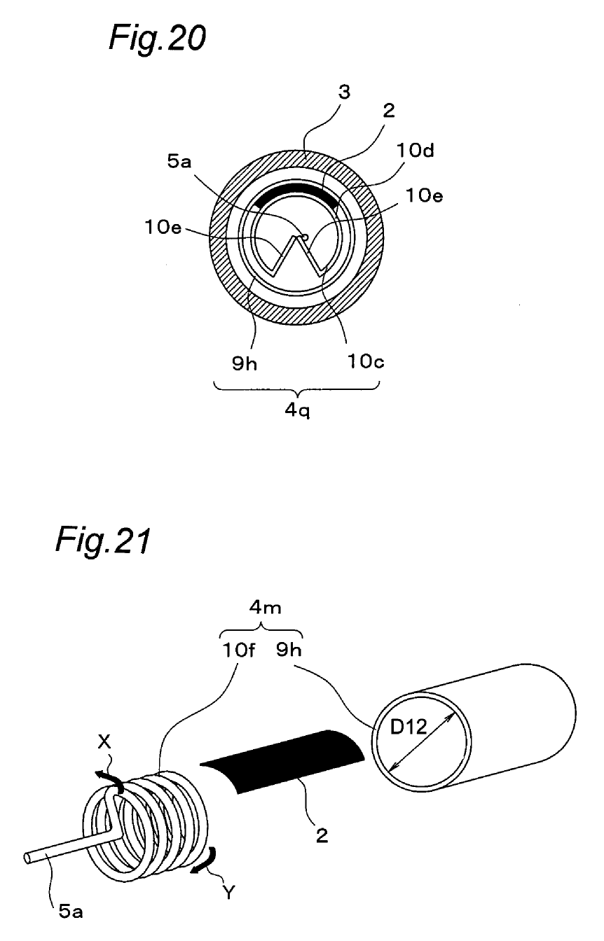

FIG. 20 shows a cross-sectional shape orthogonal to the longitudinal direction in the center portion of the container 3, and the inner diameter of the center portion of the container 3 is made greater than the outer diameter of the first holding member 9h so that, when housed in the container 3, the first holding member 9h, placed substantially on the center axis of the container 3, is not made in contact with the inner wall face of the container 3. FIG. 20 shows a state in which the holder 4q is attached to the inside of the container 3, and is a cross-sectional view showing a state in which the heat generation element 2 is sandwiched between the inner circumferential face of the first holding member 9h and the outer circumferential face of the second holding member 10c in the holder 4q.

In the heat generation unit 1c of embodiment 4, the second holding member 10c is pressed so that the outer diameter D10 is made smaller to D11, and in the contracted state, the second holding member 10c is placed inside the first holding member 9h together with the heat generation element 2. Thereafter, the regulation of the second holding member 10c is removed, and the contracted state is released so that the heat generation element 2 is sandwiched and adhered between the inner circumferential face of the first holding member 9h and the outer circumferential face of the second holding member 10c.

In the heat generation unit 1c of embodiment 4, the inner diameter D12 of the first holding member 9h is made smaller than the outer diameter DIG of the second holding member 10c in the pre-regulated state, and is also made greater than the outer diameter D11 of the second holding member 10c in the regulated state (D10≧D12>D11).

In the heat generation unit ic of embodiment 4, the second holding member 10c in the pre-regulated state is pressed from the outside to be made smaller than the inner diameter D12 of the first holding member 5h. The second holding member 10c is placed in the first holding member 9h, and by releasing the regulation thereof, the second holding member 10c is allowed to expand by the elastic force of the second holding member 10c so as to press and secure the heat generation element 2 onto the inner wall face of the first holding member 9h (see FIG. 20). It should be noted that, in embodiment 4, the arc shape of the arc portion 10d of the second holding member 10c is preferably structured to have substantially the same shape as that of the inner circumferential face of the first holding member 9h, when the regulation is released therefrom in the first holding member 9h.

As described above, the outer diameter D10 of the second holding member 10c in the pre-regulated state is made larger than the inner diameter D12 of the first holding member 9h. For this reason, as shown in FIG. 20, inside the first holding member 9h, the second holding member 10c is kept in an expanding state by its elastic force, and the outer circumferential face of the second holding member 10c is allowed to press the heat generation element 2 onto the inner circumferential face of the first holding member 9h so as to be sandwiched therebetween. Therefore, in the heat generation unit 1c of embodiment 4, since the heat generation element 2 is held by the wide sandwiching face having an arc shape in the holder 4q, the contact face of the holder 4q with the heat generation element 2 can be made wider. As a result, the holder 4q in the heat generation unit ic makes it possible to provide a holding method that ensures a uniform connection that hardly causes partial heat generation.

In the heat generation unit 1c of embodiment 4, since the holder 4q is kept in a non-contact state from the container 3, heat that is generated in the heating member 2 is not directly conducted from the holder 4q to the container 3. Therefore, according to the heat generation unit ic of embodiment 4, it is possible to design a heat generation unit having a quick temperature rise as well as a fast response speed. Its hoard be noted that, in such a structure, heat of the heat generation element 2 is transmitted to the sealed portions through the inner lead wire 5a, and, depending on the specification and structure of the heat generation unit, the sealed portions 8 tend to be subjected to high temperatures to cause a crack in the sealed portions 8, which may lead to a short service life. Therefore, in an attempt to prevent a temperature rise in the sealed portions 8, a heat-radiating block having a heat-radiating function may be effectively formed on the inner lead wire 5a.

Moreover, in the heat generation unit 1c of embodiment 4, since the outer circumferential face of the first holding member 9h may be formed at a position close to the inner circumferential face of the container 3, it is possible to ensure a wide contact area in the sandwiching process of the heat generation element 2.

Furthermore, by attaching a coil-shaped spiral portion having elasticity to the inner lead wire 5a, it is possible to provide a structure for absorbing thermal expansion due to the heat generation of the heat generation element 2.

In the case where an arrangement is made so as to allow the outer circumferential face of the first holding member 9h to come into contact with the inner circumferential face of the container 3, although the response speed of the heat generation element 2 is lowered, heat from the heat generation element 3 is radiated in the holder 4q. Therefore, with this arrangement, it is possible to prevent the power supply members 5 such as the inner lead wire 5a and the molybdenum foil 6 from having high temperatures.

Since the heat generation unit 1c of embodiment 4, arranged as described above, has a structure in which the heat generation element 2 is held on the first holding member 9h in a sandwiched state by the elastic force of the second holding member 10c that is one component of the holder 4q, it is possible to hold the heat generation element 2 by a uniform pressure applied to the holder.

FIG. 21 is a view showing another mode of the holder in the heat generation unit of embodiment 4. As shown in FIG. 21 the holder 4m is configured by a first holding member 9h and a second holding member 10f that is housed inside this first holding member 9h. The first holding member 9h is made of molybdenum and has a cylindrical shape. On the other hand, the second holding member 10f is prepared by forming a molybdenum wire into a spiral shape. The second holding member 10f has an elastic structure in which, by applying pressures to the two ends in mutually departing directions relative to the winding direction of the spiral, that is, by twisting the two ends, the inner diameter of the second holding member 10k can be shortened. By twisting the second holding member 10f in the pre-regulated state in such directions (spiral winding direction) (in directions indicated by arrows X and Y in FIG. 21) as to make the outer share of the second holding member 10f smaller, the second holding member 10f is set to a regulated state, with its outer diameter being made smaller. That is, the inner diameter D12 of the first holding member 9h is not more than the outer diameter of the second holding member 10f in the pre-regulated state, and is also made larger than the outer diameter of the second holding member 10f in the regulated state.

In the holder 4m shown in FIG. 21, the inner lead wire 5a connected to the molybdenum foil 6 embedded in the sealing portions 8 is integrally formed with the second holding member 10f.

in the case of a holder 4m shown in FIG. 21, the second holding member 10f in the regulated state after haying been twisted in such directions as to make its outer shape smaller (spiral winding directions) is disposed inside the first holding member 9h together with the heat generation element 2. Thereafter, by removing the regulation thereof, the spiral portion is allowed to expand by the elastic force of the second holding member 10f so that the heat generation element 2 is pressed onto the inner wall face of the first holding member 9h to be, set to a sandwiched and held state. It should be noted that, in the present embodiment, the outer circumferential portion of the spiral portion of the second holding member 10f is preferably made to have substantially the same shape as the shape of the inner wall face of the first holding member 9h.

As described above, since the outer diameter of the second holding member 10f in the pre-regulated state is made to be equal to or greater than the inner diameter of the first holding member 9h, the second holding member 10f is allowed to expand by the elastic force of its spiral portion inside the first holding member 9h. The outer circumferential portion of the spiral portion then presses the heat generation element 2 onto the inner wall face of the first holding member 9h so that the heat generation element 2 is made into a sandwiched state. Since the outer diameter of the spiral portion of the second holding member 10f in the pre-regulated state of its elastic member is made larger than the inner diameter of the first holding member 9h; thus, in this structure, the heat generation element 2 is sandwiched and held by the wide outer circumferential portion of the second holding member 10f and the inner circumferential face of the first holding member 9h. As a result, the holding area of the holder 4m can be made larger relative to the heat generation element 2 so that it becomes possible to suppress the holder from having partially high temperatures, and thereby a holding method capable of carrying out a connecting process with high reliability is provided.

Since the second holding member 10f shown in FIG. 21 is formed into a spiral shape, each of the spiral portions that sandwich the heat generation element 2 has a spring property in a radiating direction. Therefore, for example, in comparison with the holder 4 made by forming a plate member into a cylindrical shape, shown in FIG. 2, the heat generation element 2 is reliably sandwiched between the second holding member 10f and the inner wall face of the container 3 without requiring high dimensional precision.

Moreover, since the second holding member 10f has elasticity to expand and contract in the longitudinal direction (in the center axis direction of the spiral portion), a function for absorbing thermal expansion due to heat generation by the heat generation element 2 is exerted.

It should be noted that, by using the holder 4m shown in FIG. 21, a plurality of heat generation elements can be reliably sandwiched between the first holding member 5h and the second holding member 10f, as shown in FIG. 4. In this manner, it becomes possible to easily hold a plurality of heat generation elements by the holder 4m and thereby it becomes possible to provide a heat generation unit that can provide a heat source capable of heating a wider range.

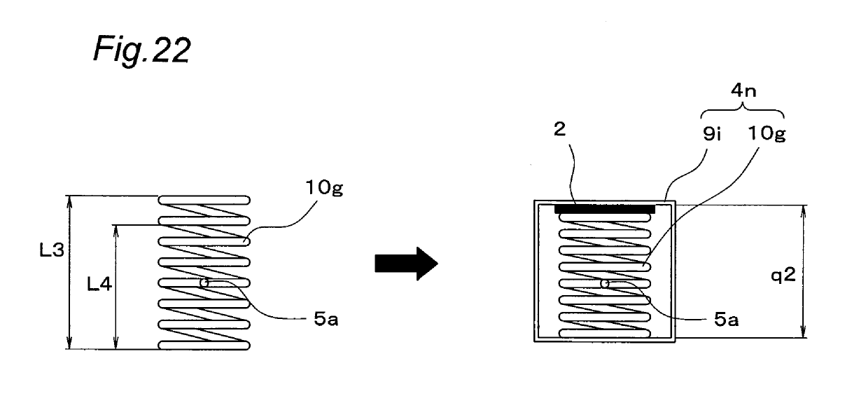

FIG. 22 is a view showing still another structure of the holder in the heat generation unit of embodiment 4. As shown in FIG. 22, a holder 4n is configured by a first holding member 9i that is a frame member having a rectangular shape (square in FIG. 22) and a second holding member 10g to be housed in the first holding member 9i. The holder 4n shown in FIG. 22 has a structure in which the second holding member 10g that is one component thereof is prepared by forming a molybdenum wire into a spiral shape as a coil spring so that the spring property in the longitudinal direction (upward and downward in FIG. 22) of the second holding member 10g is utilized. Supposing that the free length of the second holding member 10g is L3 (length before the regulated state), that the compressed length of the second holding member 10g in the pressed state is L4 (length in the regulated state), and that the length on the inner side of a portion of the first holding member 9i to which the second holding member 10q is attached is q2, a relationship indicated by L3>q2≧L4 is satisfied.

in the regulated state in which the second holding member 10g is contracted into length L4 by pressing the holding member 10g, the heat generation element 2 is disposed between a flat face on the inner wall face of the first holding member 9i (upper face on the inner wall face of the first holding member 9i shown in FIG. 22) and one of the end faces in the expanding and contracting directions of the second holding member 10g, and the regulation to the second holding member 10g is removed. With this structure, the heat generation element 2 can be kept in a reliably sandwiched state between the flat face of the first holding member 9i and the end face of the second holding member 10g.

In the holder 4n of the heat generation unit shown in FIG. 27, the second holding member 10g is formed into a spiral shape so that the spring property in the expanding and contracting directions is utilized. Therefore, in the heat generation unit of FIG. 22, it is also possible to sandwich the heat generation element 2 by utilizing the first holding member 91 that is the frame member having a rectangular shape (square shape) heat generation element.

Since the holders 4m and 4n in the heat generation unit 1c of embodiment 4 are kept in a non-contact state from the container 3, it is possible to provide a structure in which heat, generated in the heat generation element 2, is not directly transmitted from the holders 4m and 4n to the container 3. Therefore, the heat generation unit 1c of embodiment 4 is allowed to have a quick temperature rise so that it becomes possible to provide a heat generation unit having a fast response speed. It should be noted that, in such a structure, heat of the heat generation element 2 is transmitted to the sealed portions 8 through the inner lead wire 5a, and, depending on the specification and structure of the heat generation unit, the sealed portions 8 tend to be subjected to high temperatures to cause a crack in the sealed portions 8, which may lead to a short service life. Therefore, in an attempt to prevent a temperature rise in the sealed portions 8, a heat-radiating block having a heat-radiating function may be effectively formed on the inner lead wire 5a. Moreover, by attaching a coil-shaped spiral portion having elasticity to the inner lead wire 5a, it is possible to provide a structure for absorbing thermal expansion due to the heat generation of the heat generation element 2.

### Embodiment 5

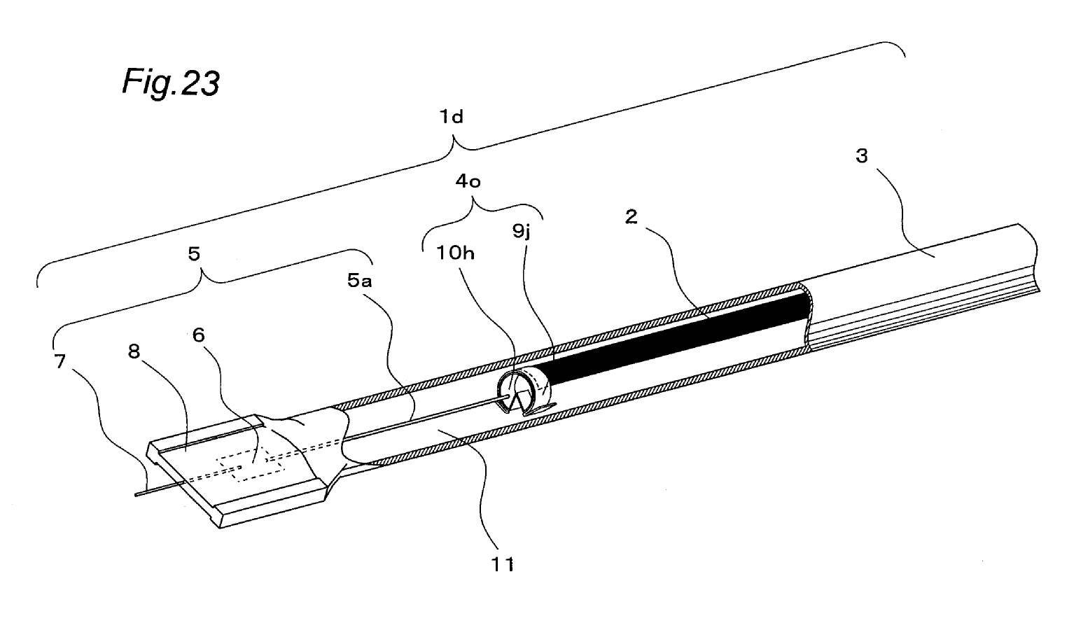

Referring to FIGS. 23 to 27, a heat generation unit according to embodiment 5 of the present invention will be described below. FIG. 23 is a perspective view showing a structure of a heat generation unit 1d according to embodiment 5. In FIG. 23, since the heat generation unit 11d has an elongated shape with two ends in a longitudinal direction having the same structure, only one of the ends is shown, with the other end being omitted from the drawing.

The heat generation unit 1d of embodiment 5 differs from the heat generation unit 1 of embodiment 1 in the structure of the holder, and the other portions are the same as those of the heat generation unit 1 of embodiment 1. Therefore, in the description of embodiment 5, components having the same functions and structures are indicated by the same reference numerals, and the descriptions of embodiment 1 will be applied to the descriptions thereof.

In the heat generation unit 1d of embodiment 5, a film-sheet-shaped heat generation element 2 is placed inside a container 3, and the heat generation element 2 is held in a predetermined position inside the container by a holder 4o. Power supply members 5 are configured by an inner lead wire 5a, molybdenum foil 6 and an external lead wire 7. One end of the inner lead wire 5a is electrically connected to the holder 4o, and the other end of the inner lead wire 5a is electrically connected to the molybdenum foil 6 that is embedded in each sealed portion 8. One end of the external lead wire 7, drawn out of the container, is connected to the molybdenum foil 6. Power is supplied to the heat generation element 2 from the external lead wire 7. The two end portions of the container 3 are fused and bonded in the sealed portions 8, and an inert gas 11 is sealed inside the container 3.

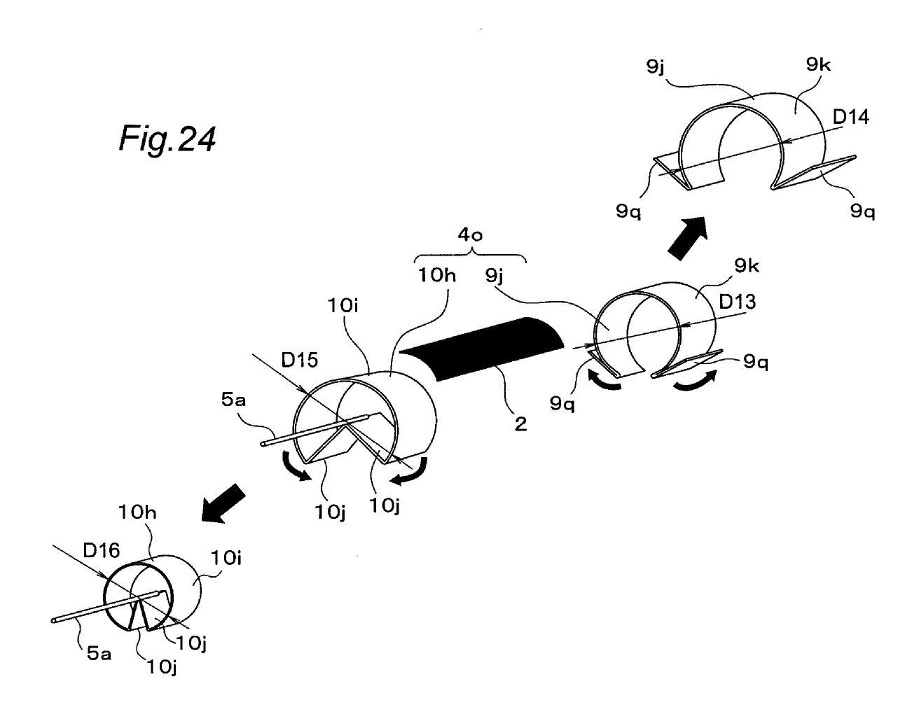

FIG. 24 is views showing a holding method for the heat generation element 2 by the holder 4o in the heat generation unit 1d of embodiment 5. The holder 4o in the heat generation unit 1d of embodiment 5 is configured by a first holding member 9j having elasticity and a second holding member 10h having elasticity and conductivity, and has a structure in which the heat generation element 2 is sandwiched by the respective elastic forces.

As shown in FIG. 24, the first holding member 9j, which is one component of the holder 4o in the heat generation unit 1d of embodiment 5, is provided with an arc portion 9k formed by bending a molybdenum plate member into an arc shape and bent portions 9q that are formed by bending the two ends of the arc portion 9k outward from the arc shape.

On the other hand, the second holding member 10h is provided with an arc portion 10i made by forming a molybdenum plate into an arc shape and two end portions 10j that are bent inward of the arc portion 10i from the two ends of the arc portion 10i. Moreover, an inner lead wire 5a is connected to the inner circumferential face of the second holding member 10h. In this embodiment, the inner lead wire 5a is secured onto one of the inner faces of the two end portions 10j of the second holding member 10h roes to be electrically connected thereto.

By moving the bent portions 9q on the two sides of the first holding member 9j of the holder 4o in circumferential directions (directions indicated by arrows X and Y in FIG. 24) in a manner so as to be expanded, the inner diameter D13 (inner diameter in a pre-regulated state) of the first holding member 9j is set to be inner diameter D14 inner diameter in a regulated state) (D14>D13).

Moreover, by pressing the second holding member 10h from the outside so as to move the two end portions 10j to approach each other, the outer diameter D15 (inner diameter in a pre-regulated state) of the second holding member 10h is made smaller to an inner diameter D16 (inner diameter in a regulated state). In the first holding member 91 and the second holding member 10h, the relationship of the inner diameters before the regulated state and after the regulated state satisfies: D14≧D15>D13≧D16.

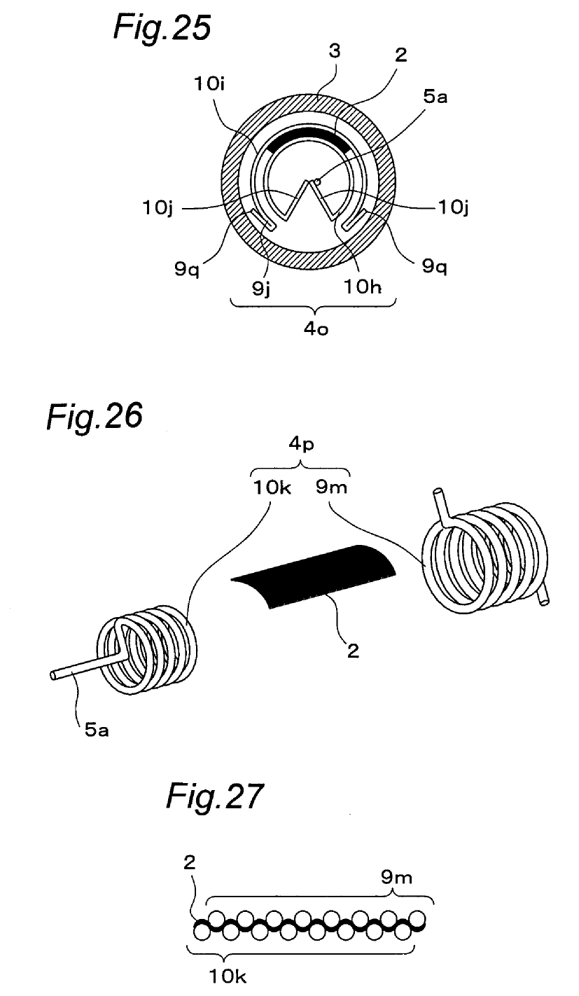

FIG. 25 is a cross-sectional view showing a state in which the heat generation element 2 is held by the holder 4o configured by the first holding member 9j and the second holding member 10h.

In the holding method of the holder 4o shown in FIG. 24, the bent portions 9q of the first holding member 9j are moved in circumferential directions (directions indicated by arrows X and Y in FIG. 24) so as to be made into an expanded state. Further, the second holding member 10h is pressed so as to allow the two end portions 10j to approach each other so as to be made into a contracted state, and the heat generation element 2 is disposed between the inner circumferential face of the first holding member 9j and the outer circumferential face of the second holding member 10h. In this state, the regulation to the bent portions 9q of the first holding member 9j is removed, and the regulations of the two end portions 10j of the second holding member 10h are also removed. In this manner, by removing both of the regulations of the first holding member 9j and the second holding member 10h, the heat generation element 2 can be firmly and uniformly sandwiched by the holding faces by the tightening pressure of the first holding member 9j and the repellent pressure of the second holding member 10h.

Moreover, the holder 4o is kept in a non-contact state from the container 3 so that in the heat generation unit 1d, heat generated in the heat generation element 2 is not directly transmitted from the holder 4o to the container 3. Therefore, the heat generation unit 1d of embodiment 5 is allowed to have a quick temperature rise so that it becomes possible to provide a heat generation unit 1d having a fast response speed it should be noted that, in such a structure, heat of the heat generation element 2 is transmitted to the sealed portions 8 through the inner lead wire 5a, and, depending on the specification and structure of the heat generation unit, the sealed portions 8 tend to be subjected to high temperatures to cause a crack in the sealed portions 8, which may lead to a short service life. Therefore, in an attempt to prevent a temperature rise in the sealed portions 8, a heat-radiating block having a heat-radiating function may be effectively formed on the inner lead wire 5a.

Moreover, by attaching a coil-shaped spiral portion having elasticity to the inner lead wire 5a, it is possible to provide a structure for absorbing thermal expansion due to the heat generation of the heat generation element 2.

The holder 4o of the heat generation unit 1d of embodiment 5 is structured by forming a plate member into an arc shape so that the heat generation element 2 can be sandwiched between the inner circumferential face of the first holding member 91 and the outer circumferential face of the second holding member 10h. As a result, since the contact area with the heat generation element 2 can be made greater, it is possible to carry out a uniform connecting process that hardly causes heat generation in the holder, and has high reliability.

FIGS. 26 and 27 are views that show still another mode of the holder in the heat generation unit 1d of embodiment 5. FIG. 26 is an exploded perspective view showing the holder 4p in this embodiment, and FIG. 27 is a cross-sectional view showing a state in which the heat generation element 2 is held by the holder 4p.

As shown in FIG. 26, the holder 4p is configured by a first holding member 9m prepared by forming a molybdenum wire into a spiral shape, and a second holding member 10k also prepared by forming a molybdenum wire into a spiral shape, and in this structure, the heat generation element 2 is held by the respective elastic forces.

In the same manner as in the first holding member 9c shown in FIG. 14, the first holding member 9m has an elastic structure in which the inner diameter of the first holding member 9m can be made larger by applying, to the two ends of the spiral portion, pressures in opposing directions relative to the winding direction of the spiral. On the other hand, in the same manner as in the second holding member 10f shown in FIG. 21, the second holding member 10k has an elastic structure in which the inner diameter of the second holding member 10k can be made smaller by applying, to the two ends of the spiral portion, pressures in mutually departing directions relative to the winding direction of the spiral. The inner diameter of the first holding member 9m prior to a regulated state is not more than the outer diameter of the second holding member 10f prior to a regulated state, and is also made larger than the outer diameter of the second holding member 10f in the regulated state (contracted state). Moreover, the inner diameter of the first holding member 9m in the regulated state (expanded state) is made larger than the outer diameter of the second holding member 10f in the pre-regulated state.

In the holder 4p shown in FIG. 26, the inner lead wire 5a, connected to the molybdenum foil 6 embedded in the sealed portions 8 is integrally formed with the second holding member 10k.

In the holding method of the heat generation element 2 of the holder 4p arranged as described above, by applying pressures in mutually opposing directions relative to the winding direction of the spiral to the first holding member 9m, the inner diameter thereof is made larger, while by applying pressures in mutually departing directions relative to the winding direction of the spiral to the second holding member 10k, the outer diameter thereof is made smaller. At this time, the heat generation element 2 is disposed on a holder between the first holding member 9m and the second holding member 10k, and the regulations to the first holding member 9m and the second holding member 10k are removed. With this arrangement, the heat generation element 2 can be reliably sandwiched between the inner circumferential portion of the first holding member 9m and the outer circumferential portion of the second holding member 10k (see FIG. 27).

The holder 4p shown in FIGS. 25 and 27 has such an advantage that both of the first holding member 9m and the second holding member 10k of the holder 4c allow spiral portions that sandwich and secure the heat generation element 2 to have spring properties; thus, this structure makes it possible to reliably sandwich the heat generation element 2 without requiring high dimensional precision. Therefore, since high machining precision is not required for the holder 4p, it is possible to easily carry out designing and manufacturing processes. Moreover, as shown in FIG. 27, since the heat generation element 2 is reliably sandwiched by the holder between the first holding member 9m and the second holding member 10k, it is possible to provide a heat source with high reliability.

It should be noted that, by using the holder 4p, a plurality of heat generation elements can be sandwiched and held, as shown in FIG. 4. Since a plurality of heat generation elements can be easily held inside the holder 4p, it becomes possible to provide a heat generation unit that can provide a heat source capable of heating a wider range.

Since the holders 4o and 4p in the heat generation unit 1d of embodiment 5 are kept in a non-contact state from the container 3, heat generated in the heat generation element 2 is not directly transmitted from the holders 4o and 4p to the container 3 in the heat generation unit 1d. Therefore, the heat generation unit 1d of embodiment 5 is allowed to have a quicker temperature rise so that it becomes possible to provide a heat generation unit having a fast response speed. It should be noted that, in this structure, heat of the heat generation element 2 is transmitted to the sealed portions 8 through the inner lead wire 5a, and, depending on the specification and structure of the heat generation unit, the sealed portions tend to be subjected to high temperatures to cause a crack in the sealed portions 8, which may lead to a short service life. Therefore, in an attempt to prevent a temperature rise in the sealed portion 8, a heat-radiating block having a heat-radiating function may be effectively formed on the inner lead wire 5a.

Moreover, by attaching a coil-shaped spiral portion having elasticity to the inner lead wire 5a, it is possible to provide a structure for absorbing thermal expansion due to the heat generation of the heat generation element 2.

The film sheet-shaped heat generation elements 2 used for the heat generation units from embodiment 1 to embodiment 5 are prepared through processes in which powder mainly composed of natural graphite is molded, fired and subjected to a rolling process to be formed into a film sheet. The heat generation element 2 thus manufactured generally has a thermal conductivity of 200 to 400 W/m·k; however, more preferably, a heat generation element, which is a film sheet formed by subjecting a polymer film to a heating process to be fired in a high-temperature atmosphere, for example, 2400° C. or more, to be formed into graphite, and has a superior two dimensional isotropic thermal conductive property with a thermal conductivity of 600 to 950 W/m·k, is utilized.

The polymer film used for the material of the heat generation element 2 in the heat generation unit of the present invention may be at least one kind of polymer film selected from the group consisting of polyoxadiazole, polybenzothiazole, polybenzobisthiazole, polybenzooxazole polybenzobisoxazole, polypyromellitic imide, polyphenyiene isophthalic polyphenyiene benzoimidazole polyphenylene benzobisimidazole, polythiazole and polyparaphenylenevinylene. The selected polymer film is subjected to a heating process at 2400° C. or more in an inert gas, and a controlling process is carried out by adjusting the pressure of a treatment atmosphere of a gas generated during the graphite-forming process, and the graphite thus obtained is further subjected to a rolling process, if necessary, so that good film-sheet-shaped graphite can be obtained it is particularly preferable to use this film-sheet-shaped graphite as the material for the heat generation element 2.

In addition to the above-mentioned material, a sheet-shaped material, formed by, for example, carbonaceous fibers or carbonaceous fibers to which resin is applied and adhered and which are fired, may be used as long as it has pliability, and needless to say, this material provides the same effect as the aforementioned embodiments.

It should be noted that, the two dimensional isotropic heat conductive property refers to heat conduction that is exerted in the same manner in all directions within one plane, and is not limited to the same heat conductive property exerted only in a fiber direction (X-axis direction) in the case where carbon fibers in one direction are used, or by the same heat conductive property exerted only in fiber directions (X-axis direction and Y-axis direction) in the case where crossed fibers are used.

In the heat generation units in embodiments 1 to 5 of the present invention, descriptions have been given by exemplifying the case in which a molybdenum material is used as the material for the holder (including the holding member); however, another material may be used as long as, when formed into a holder and a holding member, it exerts conditions, such as elasticity, heat resistance and durability, that satisfy those conditions described in the aforementioned embodiments, and the same effects can be obtained. For example, tungsten, stainless alloys or the like may be used as other materials used for the holder in the present invention.

In heat generation units in embodiments 1 to 5 of the present invention, the holding method for the film-sheet-shaped heat generation element has been described; however, depending on the thicknesses of the film-sheet-shaped heat generation elements, another member having a conductive property, for example, a carbonaceous sheet, a metal thin-film sheet or the like, may be disposed on at least one face, or preferably on the two faces of a sandwiching portion of the film-sheet-shaped heat generation element, as a buffering member, so that it becomes possible to provide a sandwiched structure in a further stable manner.

Moreover, in heat generation units in embodiments 1 to 5 of the present invention, descriptions have been given by exemplifying the case in which quartz glass is used as the material for the container 3; however, in addition to this, other materials, such as glasses, like soda lime glass, borosilicate glass and lead glass, and ceramic materials, such as alumina, cordierite, mullite, zirconia, magnesia and calcia, may also be used. In the case where ceramic materials are used as the container, since some of the materials are unable to be sealed, it is necessary to additionally prepare a mechanism capable of sealing an inert gas such as argon gas, or a structure in which the preset heat generation temperature of the heat generation element 2 is set to about 40° C. so as to be heated at such temperatures as to be applicable even in the atmosphere.

When the preset heat generation temperature of the heat generation element 2 is set to about 200° C. or less, resins such as silicon resin may also be used as the material for the container 3.

In the heat generation units in embodiments 1 to 5 of the present invention, also in the examples in which the holder and the inner lead wire are formed by using other members, it becomes possible to suppress heat generation in the connected portion by integrally molding the holder and the inner lead wire, and consequently to provide a desirable structure.

All of the foregoing descriptions in the embodiments show examples embodying the present invention; however, the present invention is not limited to these examples, and various modifications may be made therein by using technical features of the present invention.

### INDUSTRIAL APPLICABILITY

Since the heat generation unit according to the present invention is provided with holding means that is superior in safety and has high reliability, the heat generation unit according to the present invention can be effectively used as a heat source for a heating device.

What is claimed is:

1. A heat generation unit comprising:
a heat generation element having a film-sheet shape that generates heat when a voltage is applied thereto;
power supply members that supply power to the heat generation element;
a holder having an elastic force that is used for holding the heat generation element; and
a container that contains the heat generation element and the holder therein,
wherein the heat generation element is held at a predetermined position inside the container by the elastic force of the holder, and the power from the power supply members is supplied through the holder.

2. The heat generation unit according to claim 1, wherein the heat generation element is structured to be pressed onto an inner wall face of the container by an expanding operation of the holder to be held thereon.

3. The heat generation unit according to claim 2, wherein the container further comprises a cylindrical portion that contains the heat generation element and the holder, and the holder includes an arc portion having a shape corresponding to the inner wall face of the container, the arc portion in a free state that is a state prior to a regulated state haying a diameter that is greater than a diameter of the cylindrical portion, the arc portion in a regulated state having a diameter that is smaller than the diameter of the cylindrical portion, with the heat generation element being held by an expanding operation of the arc portion.

4. The heat generation unit according to claim 2, wherein the container further comprises a cylindrical portion that contains the heat generation element and the holder, and the holder comprises a spiral portion prepared by forming a wire member into a coil shape, the spiral portion in a free state that is a state prior to a regulated state having a diameter that is greater than the diameter of the cylindrical portion, the spiral portion in a regulated state having a diameter that is smaller than the diameter of the cylindrical portion, with the heat generation element being held by an expanding operation of the spiral portion.

5. The heat generation unit according to claim 3, wherein the heat generation element is formed by a material having a two dimensional isotropic thermal conductivity, with the thermal conductivity being set to a conductivity of 200 W/m·k or more.

6. The heat generation unit according to claim 3, wherein the heat generation element is formed by a graphite film obtained by subjecting a polymer film to heating treatment at a temperature of 2400° C. or more.

7. The heat generation unit according to claim 1, wherein the heat generation element is held by a sandwiching operation of the holder, and the holder is secured onto a predetermined position on the container by an expanding operation of the holder placed in contact with the container.

8. The heat generation unit according to claim 7, wherein the container further comprises a cylindrical portion that contains the heat generation element and the holder, and the holder includes an arc portion haying a shape corresponding to the inner wall face of the container and a sandwiching portion having a flat face, the arc portion in a free state that is a state prior to a regulated state having a diameter that is greater than the diameter of the cylindrical portion, the arc portion in a regulated state haying a diameter that is smaller than the diameter of the cylindrical portion, with the heat generation element being held by respective portions of the sandwiching portion of the holder after the regulated state.

9. The heat generation unit according to claim 8, wherein the heat generation element is formed by a material having a two dimensional isotropic thermal conductivity, with the thermal conductivity being set to a conductivity of 200 W/m·k or more.

10. The heat generation unit according to claim 8, wherein the heat generation element is formed by a graphite film obtained by subjecting a polymer film to heating treatment at a temperature of 2400° C. or more.

11. The heat generation unit according to claim 1, wherein the holder includes a first holding member and a second holding member, and is structured so that, by a sandwiching operation of the first holding member and the second holding member, the heat generation element, placed between the first holding member and the second holding member, is held.

12. The heat generation unit according to claim 11, wherein one of the first holding member and the second holding member has an elastic property so that one of the holding members is sandwiched and held by an elastic force of the other holding member.

13. The heat generation unit according to claim 11, wherein both of the first holding member and the second holding member have an elastic property so that one of the holding member is sandwiched and held by the other holding member by mutual elastic forces.

14. The heat generation unit according to claim 12, wherein the heat generation element is formed by a material having a two dimensional isotropic thermal conductivity, with the thermal conductivity being set to a conductivity of 200 W/m·k or more.

15. The heat generation unit according to claim 12, wherein the heat generation element is formed by a graphite film obtained by subjecting a polymer film to heating treatment at a temperature of 2400° C. or more.
